(19) United States
(12) Patent Application Publication
(10) Pub. No.: US 2026/0290193 A1
(43) Pub. Date: Sep. 24, 2026

(54) SYSTEM

(71) Applicant: SoftBank Group Corp., Tokyo (JP)

(72) Inventor: Hidejiro HARADA, Tokyo (JP)

(73) Assignee: SoftBank Group Corp., Tokyo (JP)

(21) Appl. No.: 19/567,065

(22) Filed: Mar. 14, 2026

(30) Foreign Application Priority Data
Mar. 19, 2025 (JP) 2025-045139

(51) Int. Cl. G09B 7/04; G06F 40/103; G06F 40/205; G06F 40/284; G06F 40/40; G06N 3/0475

(52) U.S. Cl. CPC G09B 7/04; G06F 40/103; G06F 40/205; G06F 40/284; G06F 40/40; G06N 3/0475

(57) ABSTRACT

A system includes a processor that is configured to generate, for a generative AI model, a first prompt that instructs the generative AI model to generate one or more questions for measuring a user's level of understanding with respect to specific information, analyze an answer provided by the user to at least one of the one or more questions and, using the generative AI model, evaluate the user's level of understanding and discover related information and surrounding information based on the analyzed answer, and recognize an emotion of the user and, based on the recognized emotion, generate, for the generative AI model, a second prompt that instructs the generative AI model to dynamically adjust at least one of questions and content.

### CROSS-REFERENCE TO RELATED APPLICATION

This application is based on and claims priority under 35 USC 119 from Japanese Patent Application No. 2025-045139 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-assisted learning and information retrieval systems generally rely on static question sets, fixed content recommendations, or simple rule-based adaptation that does not fully reflect a user's actual level of understanding, interests, or emotional state. As a result, such systems often fail to present questions that accurately measure a user's comprehension with respect to specific information, and cannot flexibly discover and surface related or surrounding information in a manner tailored to the user's evolving knowledge. Furthermore, existing systems typically do not recognize a user's emotion or use such emotional information to dynamically adjust questions or content, leading to reduced engagement, inappropriate difficulty levels, and suboptimal learning outcomes. In addition, even when generative AI models are available, there is insufficient control over how such models are prompted to generate questions, evaluate understanding, discover relevant information, or select content in a consistent, systematized way. Accordingly, there is a need for a system that generates and manages prompts for one or more generative AI models so as to (i) generate appropriate questions for measuring understanding, (ii) analyze answers and evaluate user understanding while discovering related information, and (iii) recognize and utilize user emotion to dynamically adjust questions and content, thereby improving personalization, engagement, and learning effectiveness.

### SUMMARY

To address the above-described problems, according to one aspect of the present invention, there is provided a system comprising a processor, wherein the processor is configured to generate, for a generative AI model, a first prompt that instructs the generative AI model to generate one or more questions for measuring a user's level of understanding with respect to specific information. The processor is further configured to analyze an answer provided by the user to at least one of the one or more questions and, using the generative AI model, evaluate the user's level of understanding and discover related information and surrounding information based on the analyzed answer. In addition, the processor is configured to recognize an emotion of the user and, based on the recognized emotion, generate, for the generative AI model, a second prompt that instructs the generative AI model to dynamically adjust at least one of questions and content. In some embodiments, the processor is configured to analyze the user's answer and generate, for the generative AI model, a third prompt that instructs the generative AI model to dynamically generate one or more additional questions based on the analyzed answer. In certain embodiments, the processor is configured to evaluate at least one of the user's level of understanding, the user's interest, and the user's emotion, and generate, for the generative AI model, a fourth prompt that instructs the generative AI model to select and present content based on the evaluation. By systematically generating these prompts and controlling the generative AI model in this manner, the system can measure understanding more accurately, surface related and surrounding information, and adapt questions and content in real time according to user understanding, interests, and emotional state, thereby solving the aforementioned problems.

The term “system” refers to a combination of hardware and software components, including at least one processor and associated memory or storage, that cooperate to perform the functions described in the claims.

The term “processor” refers to one or more hardware processing units, such as a central processing unit (CPU), a microprocessor, or other computing circuitry, that executes instructions to perform specified operations.
The term “generative AI model” refers to a machine learning model, such as a large language model or other generative model, that is configured to generate text or other content in response to input data, including prompts.
The term “prompt” refers to data provided as input to a generative AI model, the data including instructions, constraints, or context that guide the generative AI model to generate a desired output.
The term “question” refers to a text or other content item generated or selected for the purpose of eliciting an answer from a user so as to measure the user's level of understanding regarding specific information.
The term “specific information” refers to a defined subject matter, topic, concept, dataset, or content domain with respect to which the user's level of understanding is to be measured.
The term “user” refers to a human individual who interacts with the system, provides answers to questions, and receives questions and content generated or selected by the system.
The term “user's level of understanding” refers to a degree or extent of the user's comprehension, knowledge, or proficiency regarding specific information, as evaluated by the system using the generative AI model.
The term “answer” refers to content, typically in natural language text form, that is provided by the user in response to a question and is subject to analysis by the system.
The term “analyze” refers to processing an answer or other data to extract features, infer meaning, or derive information, including but not limited to determining correctness, completeness, or relevance.
The term “evaluate” refers to determining a quantitative or qualitative measure, score, or classification that represents at least the user's level of understanding, interest, or emotion based on analyzed data.
The term “related information” refers to information that is associated with or relevant to the specific information, such as prerequisite concepts, detailed explanations, or extensions of the specific information.
The term “surrounding information” refers to information that is adjacent or complementary to the specific information, including neighboring topics, broader context, or tangentially connected concepts.
The term “emotion” refers to an affective state of the user, such as interest, boredom, confusion, frustration, satisfaction, or engagement, as recognized or inferred by the system.
The term “recognize an emotion of the user” refers to detecting or inferring the user's emotional state using one or more inputs, which may include the user's answers, interaction patterns, or other signals.
The term “content” refers to information items, including but not limited to text, images, audio, video, documents, or interactive materials, that are presented to the user for learning, feedback, or engagement.
The term “dynamically adjust” refers to changing, selecting, or modifying questions or content in real time or near real time in response to updated evaluations of the user's level of understanding, interest, or emotion.
The term “dynamically generate” refers to causing the generative AI model to newly create questions or other content in real time or near real time based on current user data, including answers and evaluations.
The term “select and present content” refers to choosing one or more content items from among multiple candidates and providing the chosen items to the user via an interface or output device.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

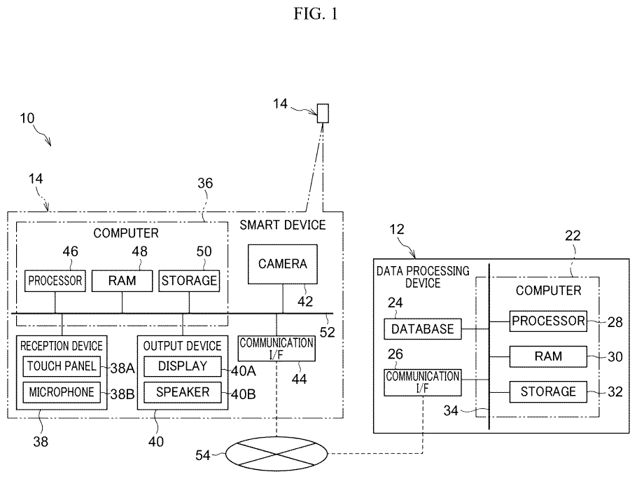

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

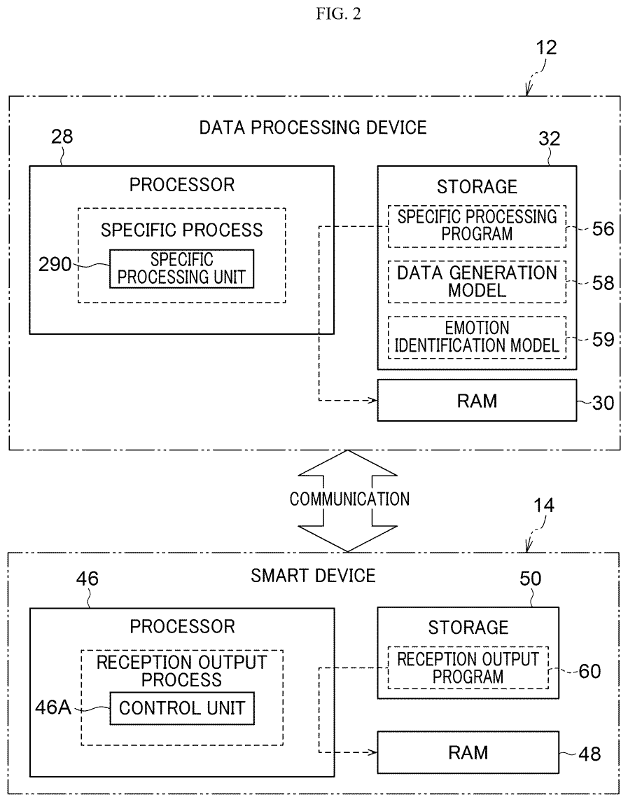

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems typically rely on static question sets, manually authored content, or simple rule-based adaptation. Such systems often require human experts to design and continuously update questions and content, which leads to high maintenance costs and limited scalability. Furthermore, even when machine learning components are included, they frequently operate as black-box subsystems that merely generate text, without being tightly integrated into the core control logic of the system. As a result, the underlying computer resources are not efficiently utilized to dynamically structure, store, and adapt question-and-answer workflows at scale.

In addition, in many existing architectures, the processing of user input, the generation of assessment items, and the provision of feedback are implemented as loosely coupled modules, each with ad hoc data formats. This leads to significant overhead in parsing and transforming unstructured outputs from text generation engines, creates latency in end-to-end processing, and complicates robust error handling in the presence of malformed or noisy output. Consequently, the ability of the computer system to provide timely, structured, and context-aware assessment content is degraded.
Moreover, typical generative systems do not maintain fine-grained associations between generated questions, corresponding user answers, and evaluation results within a unified data model managed by a processor. Without such associations, the system cannot compute accurate progress indicators or adapt subsequent questions in a principled, automated manner. This prevents effective use of processor and memory resources to drive iterative and personalized assessment loops.
Still further, known systems generally do not combine understanding-degree evaluation with extraction of related terms and peripheral fields in an integrated server-side workflow. They therefore fail to leverage natural language processing and recommendation processing as core mechanisms for generating related content candidates, such as learning materials and entertainment-oriented content, in a form that is directly consumable by a user terminal. This separation limits the extent to which the computer system can automatically provide coherent, multi-step learning pathways.
Additionally, although user interaction data such as operation patterns and dwell times are sometimes collected, they are often treated simply as analytics, not as primary inputs to a runtime control loop that dynamically shapes the prompt sentences to a generative AI model.
As a result, changes in user interest or engagement are not reflected in real time in the difficulty, scope, or format of subsequent questions and explanations. This underutilization of interaction data leads to suboptimal use of computational resources for adaptive content generation.
Accordingly, there is a need for an improved computer-implemented system in which a processor centrally manages (i) the generation of structured prompt sentences to a generative AI model, (ii) the structuring and storage of the model's outputs as machine-usable inquiry information, (iii) the association of such inquiry information with user answer data and evaluation results, and (iv) the dynamic generation of further prompts and related content based on learning progress and user interest signals. Such an arrangement can improve the functioning of the computer system itself by reducing manual configuration, minimizing parsing overhead, organizing data in a form directly usable by downstream components, and enabling more efficient, iterative use of generative AI models as part of a closed-loop control architecture.

The specific processing by the specific processing unit 290 of the data processing device 12 in Example 1 is realized by the following means.

The present invention provides a server comprising a processor configured to analyze learning request data including learning target information received from a user terminal, the learning request data including control information regarding a number of questions, a language type, and a difficulty level, and to generate a structured prompt sentence for instructing a generative AI model to generate a plurality of inquiries for evaluating a degree of understanding of the learning target information; to generate model call request data including the prompt sentence, to transmit the model call request data via a network, to receive inquiry generation result data from the generative AI model, to analyze the inquiry generation result data, to convert unstructured text data into structured inquiry information in a format directly presentable on the user terminal by extracting individual inquiry sentences based on line break information, numbering information, or data description format information, and to store the inquiry information in a recording medium and transmit the inquiry information to the user terminal; to store user answer data received from the user terminal in association with the inquiry information stored in the recording medium, to generate a further prompt sentence for causing the generative AI model to perform understanding-degree evaluation and feedback generation based on the user answer data, to transmit model call request data including the further prompt sentence, to receive evaluation result data from the generative AI model, to analyze the evaluation result data, and to transmit, to the user terminal, understanding-degree indices and explanation information based on the evaluation result data; to extract related terms and peripheral fields based on the learning target information and the understanding-degree indices by using a natural language processing program or a recommendation processing program, to search for related content candidates including book information, video information, or other entertainment information, to select one or more of the related content candidates, and to generate related content presentation information for presentation of the selected related content candidates on the user terminal; and to update learning progress information based on the user answer data and the understanding-degree indices, to estimate a degree of user interest based on user operation information or stay time information, to generate control information for stepwise generation of additional inquiries or follow-up inquiries by changing the prompt sentences for the generative AI model according to the learning progress information and the degree of user interest, and to transmit, to the user terminal, inquiry information including the additional inquiries or the follow-up inquiries. This enables the computer system to more efficiently and reliably orchestrate generative AI resources, to automatically structure and persist generated text as machine-usable inquiry information, to maintain consistent associations among questions, answers, and evaluations, and to dynamically adapt subsequent prompts, questions, and related content in real time based on computed understanding-degree indices and user interest signals, thereby improving the overall functioning and technical performance of the learning support infrastructure.

The term “learning request data” refers to data received from a user terminal that specifies learning target information together with one or more control parameters such as a number of questions, a language type, and a difficulty level.
The term “learning target information” refers to information indicative of a subject, topic, concept, or content area that a user desires to study or understand, and which serves as a basis for generating inquiries and related content.
The term “user terminal” refers to an information processing apparatus operated by a user, such as a computing device including a display and input interface, that transmits learning request data and user answer data to a server and receives inquiry information, feedback information, and related content presentation information.
The term “control information” refers to information included in learning request data that specifies parameters governing generation or presentation of inquiries, such as a desired number of questions, a language type, a difficulty level, or other configuration values.
The term “processor” refers to a hardware processing unit, such as a central processing unit or other computing circuitry, configured to execute instructions that implement the analysis, generation, structuring, storage, and transmission operations described in the claims.
The term “prompt sentence” refers to a sequence of natural language text or machine-interpretable instructions configured to be provided as input to a generative AI model in order to cause the model to generate inquiries, evaluations, feedback, or content descriptions in accordance with specified conditions.
The term “generative AI model” refers to an artificial intelligence model, such as a probabilistic or neural network-based text generation model, that generates output text or other content in response to an input prompt sentence.
The term “model call request data” refers to data generated by the processor that encapsulates at least a prompt sentence and, optionally, one or more generation parameters, and that is transmitted to a generative AI model via a network or internal interface to request generation of output.
The term “inquiry” refers to a question or interrogative sentence generated for the purpose of assessing or eliciting a user's understanding of learning target information.
The term “inquiry generation result data” refers to output data received from a generative AI model in response to a prompt sentence that requested generation of inquiries, the output data including text representing one or more inquiries.
The term “inquiry information” refers to structured data representing one or more inquiries in a format suitable for storage and presentation, and including at least an inquiry text and optionally additional metadata such as identifiers, indices, or difficulty attributes.
The term “recording medium” refers to a non-transitory storage device or storage subsystem, such as a memory, storage drive, or database, in which inquiry information, user answer data, evaluation result data, or other related data are stored.
The term “user answer data” refers to data including one or more user-generated responses to inquiries, the data being received from a user terminal and associated with corresponding inquiries.
The term “understanding-degree evaluation” refers to a process in which a generative AI model or other component analyzes user answer data relative to inquiries or learning target information to produce an assessment of a user's level of understanding.
The term “evaluation result data” refers to data obtained from a generative AI model or evaluation component that represents results of understanding-degree evaluation, including for example scores, ratings, or qualitative assessments.
The term “understanding-degree indices” refers to numerical or categorical indicators derived from evaluation result data that quantify or characterize a user's level of understanding of learning target information.
The term “explanation information” refers to descriptive text or other content derived from evaluation result data that explains an evaluation outcome, provides feedback on user answers, or clarifies concepts related to learning target information.
The term “natural language processing program” refers to software configured to analyze or process natural language text, such as by tokenizing, extracting terms, identifying topics, or performing other linguistic or semantic operations.
The term “recommendation processing program” refers to software configured to compute or select content items that are related to learning target information or inferred user interests, for example by matching extracted terms to item metadata or by applying recommendation algorithms.
The term “related terms” refers to words or phrases identified as having a semantic or contextual relationship to learning target information, such as synonyms, associated concepts, or subtopics.
The term “peripheral fields” refers to subject areas or domains that are not identical to but are contextually or conceptually adjacent to learning target information, and that may be useful for expanding a user's knowledge.
The term “related content candidates” refers to content items identified as potentially relevant to learning target information or a user's interests, including items such as textual materials, audiovisual materials, or other digital resources.
The term “book information” refers to metadata or descriptive data about a textual publication, such as a title, author, subject classification, or access information associated with a book or similar document.
The term “video information” refers to metadata or descriptive data about an audiovisual resource, such as a title, description, subject classification, or access link associated with a video.
The term “entertainment information” refers to metadata or descriptive data about content primarily intended for engagement or enjoyment, including but not limited to books, videos, games, or other media that can also serve as educational or motivational material.
The term “related content presentation information” refers to structured data generated by the processor that specifies one or more related content candidates and associated details in a form suitable for presentation on a user terminal.
The term “learning progress information” refers to data representing a computed state of a user's progression in understanding or mastering learning target information, derived from one or more of user answer data, understanding-degree indices, usage history, or interaction patterns.
The term “user operation information” refers to data indicative of a user's interactions with a user terminal or application interface, such as clicks, taps, scrolls, selections, input events, or navigation operations.
The term “stay time information” refers to data indicating a duration for which a user remains on or interacts with a particular screen, inquiry, content item, or interface element, and which is used as a measure of engagement or interest.
The term “degree of user interest” refers to an estimated level of user engagement or preference with respect to learning target information, inquiries, or content items, computed based on user operation information, stay time information, or related interaction data.
The term “additional inquiries” refers to inquiries generated after initial inquiries based on updated learning progress information or user interest information, and intended to further assess or deepen understanding.
The term “follow-up inquiries” refers to inquiries generated in response to previous user answers, evaluations, or interactions, and designed to address specific gaps, misunderstandings, or emerging interests.
The term “content description sentences” refers to natural language sentences that describe, summarize, or explain content items, topics, or concepts, and that are generated by a generative AI model according to a prompt sentence.
The term “question range” refers to a scope or subset of topics, subtopics, or concept categories that an inquiry or set of inquiries is configured to cover.
The term “question format” refers to a structural pattern or type of an inquiry, such as open-ended questions, multiple-choice questions, true/false questions, or other interrogative forms.

In one embodiment, a server executes a learning support program on a general-purpose computer system including at least one central processing unit (CPU), a graphics processing unit (GPU), a main memory, a non-volatile storage device such as a solid state drive, and a network interface. The server runs an operating system such as a Unix-like operating system and application server software such as a web framework runtime. The server stores a generative AI model, a natural language processing program, a recommendation processing program, and application logic programs in the non-volatile storage device, and loads portions thereof into the main memory for execution by the CPU and GPU.

The server uses a hardware accelerator such as a GPU to execute a generative AI model implemented as a transformer-based neural network. The transformer architecture includes an input embedding layer, a plurality of self-attention layers, feed-forward layers, and an output projection layer. The server uses a machine learning framework such as a tensor computation library to execute linear algebra operations (matrix multiplications, vector additions, normalization operations, softmax calculations) required for the transformer computation.
The server stores model parameters (weights and biases) as multidimensional arrays in GPU memory and accesses them during inference.
The server represents learning request data, inquiry information, user answer data, evaluation result data, and related content presentation information as structured records in one or more databases implemented using a relational database management system. The server assigns a unique identifier to each learning session and associates each inquiry, user answer, and evaluation result with the corresponding learning session identifier. The server maintains schema definitions that include fields for learning target information, control information, prompt sentences, model call request data, timestamps, and user identifiers.
The server generates a prompt sentence for a generative AI model by concatenating fixed template strings with variable portions that include learning target information, a requested number of questions, a language type, and a difficulty constraint. The server constructs the prompt sentence in a controlled format to reduce ambiguity in the model output and to facilitate deterministic parsing. For example, the server may generate a prompt sentence of the following form:
“The information that the user wants to learn is ‘quantum mechanics’. Please generate 5 inquiries that measure the user's level of understanding of this information. Each inquiry should be a concise question in English and should focus on a core concept. Return the result as a numbered list of questions, each on a new line, without any additional commentary.”
The server, in another example, may generate a prompt sentence for understanding-degree evaluation and feedback generation as follows:
“You are an expert tutor. Here is a question and a student's answer.
Question: ‘What is the role of the Schrödinger equation in quantum mechanics?’
Student answer: ‘It determines how the wave function changes over time.’
Please evaluate the correctness on a scale from 1 to 5 and provide a brief explanation in 2 to 3 sentences. Return your result in the following format: ‘Score: <number>’ on the first line and ‘Comment: <text>’ on the second line.”
The server, by defining such constrained prompt sentences, converts inherently unstructured natural language interactions into semi-structured text that exhibits predictable delimiters and formatting cues. The server subsequently exploits these cues to perform deterministic parsing without complex heuristic procedures, thereby reducing CPU load, memory allocations, and error rates in the downstream processing pipeline.
The server generates model call request data by assembling the prompt sentence together with model configuration parameters such as maximum output length, sampling temperature, and top-k or top-p values. The server encodes the model call request data as a structured message to be transmitted to a generative AI model inference service. In a deployed configuration, the server either calls a locally hosted inference engine through an internal application programming interface or calls a remote inference service via a network protocol.
In the local configuration, the server uses a tokenizer to convert the prompt sentence into a sequence of integer token identifiers and stores these identifiers in a contiguous memory buffer passed to the GPU inference routine.
The server causes the generative AI model to perform inference by executing forward passes through the transformer layers. Each layer computes self-attention scores by calculating dot products between query and key vectors, normalizing the scores, and multiplying by value vectors, followed by linear transformations and nonlinear activations. The server retrieves the generated output token sequence from the GPU memory and decodes it back into a text string using the same tokenizer's vocabulary mapping. Because the server configures the generative AI model with fixed maximum output lengths and controlled sampling parameters, the server limits resource consumption and ensures that outputs conform to the expected structural envelope.
The server converts the text output of the generative AI model into structured inquiry information by analyzing line breaks, numbering patterns, and explicit formatting markers.
The server, for example, splits the text at newline characters to obtain individual lines, discards lines that are empty or contain only numbering characters, and removes leading numbering tokens such as “1.”, “2.”, or “Q1:”. The server normalizes whitespace and stores each resulting inquiry sentence together with an automatically assigned index value, a generated identifier, and metadata such as language type, creation timestamp, and source prompt identifier. The server commits this inquiry information as rows in a database table and creates indexes on key fields to accelerate subsequent retrieval operations.
The server improves data management by enforcing a strict mapping from prompt sentences to sets of inquiries and from sets of inquiries to sets of answers and evaluation results. The server stores these relationships as foreign key associations in the database. By doing so, the server can execute efficient join operations and filtered queries when computing learning progress information, without scanning entire logs or relying on unstructured text searches.
This structured representation reduces input-output overhead and CPU cycles required for analytical queries and makes the overall system more scalable under high user load.
The server analyzes user answer data received from a terminal by associating each answer with an inquiry identifier and a learning session identifier. The server stores the user answer text and optional metadata such as input duration, revision count, and answer length. The server then constructs a further prompt sentence that embeds both the original inquiry and the corresponding user answer in a consistent template. Because the server embeds explicit labels such as “Question:” and “Student answer:”, the server constrains the generative AI model's attention to relevant sections of the input, thereby improving the reliability of the evaluation result data and reducing the variance of generated scores.
The server uses the generative AI model to calculate evaluation result data by instructing the model, via the prompt sentence, to output a score in a predetermined numerical range and an explanatory comment in a predetermined structure. The server parses the result by locating a line beginning with a label such as “Score:” and extracting the numeric value, then locating a line beginning with “Comment:” and extracting the explanatory text. The server handles parsing failures by applying fallback rules, such as scanning for the first integer within a valid range or truncating comments at a maximum length. This controlled output parsing leads to a consistent internal representation of understanding-degree indices and explanation information.
The server computes learning progress information based on sequences of understanding-degree indices generated over multiple sessions and topics. The server aggregates scores by inquiry, by topic, or by concept, using statistical aggregations stored in dedicated database tables. The server can compute moving averages, difficulty-adjusted indices, or trend indicators. Because these computations operate on normalized numerical fields rather than unstructured strings, the server can execute them using optimized database functions or in-memory numerical libraries, thereby improving calculation speed and reducing memory usage.
The server extracts related terms and peripheral fields by applying a natural language processing program to learning target information, inquiry texts, user answer data, and explanation information. The server uses components such as tokenizers, part-of-speech taggers, and named-entity recognizers to identify candidate terms and then applies similarity measures (for example, cosine similarity between word embedding vectors) to select terms that are semantically related but not identical to the main topic. The server, by performing this computation at the server side using precomputed word embeddings and indexing structures, can rapidly compute related term lists for many users simultaneously without transmitting large embedding models to terminals.
The server applies a recommendation processing program to map related terms and peripheral fields to related content candidates. The server stores metadata for content items, such as tags and textual descriptions, in an indexed format and uses term-frequency and inverse-document-frequency weighting or vector similarity search techniques to retrieve the most relevant items. The server then constructs related content presentation information that includes identifiers, titles, summaries, and access links, and delivers this information to the terminal in a structured form. The server enables a reduction in communication load by filtering and ranking related content on the server and transmitting only top-ranked items to the terminal.
The server estimates a degree of user interest based on user operation information and stay time information received from the terminal. The server stores event logs for operations such as scrolling, clicking, or editing, and computes engagement features such as average dwell time per inquiry, frequency of revisiting specific questions, and abandonment rates. The server can normalize these features across users or topics and derive an interest score. The server then uses this interest score, together with learning progress information, to adjust prompt sentences, for example by increasing the requested difficulty level when interest and understanding are high, or by narrowing the question range when interest is high but understanding-degree indices are low. These adaptive adjustments are encoded into the prompt sentence as explicit conditions, such as “focus on basic concepts” or “generate more challenging, application-oriented questions,” which in turn influence the generative AI model's output distribution.
The server achieves a technical improvement over conventional human-authored or rule-based systems by using generative AI models in a tightly constrained and structured manner.
The server does not merely replace human authorship but reorganizes the entire data flow so that prompt sentences, model outputs, parsing procedures, and database structures are co-designed. This co-design allows the server to minimize ambiguous outputs, reduce parsing complexity, and maintain robust, machine-usable records. The server therefore reduces processing latency and error rates, increases throughput under concurrent usage, and enables precise adaptation logic that would be infeasible with manually crafted content at scale.
The terminal operates as a client-side device for user interaction. The terminal includes a display, one or more input devices, a processor, a memory, and a communication interface.
The terminal executes an application or browser-based program that presents user interfaces for entering learning target information, reviewing inquiries, entering answers, and viewing feedback and related content. The terminal formats user inputs into structured messages and transmits them to the server using secure communication protocols. The terminal receives structured inquiry information, explanation information, and related content presentation information from the server and renders them on the display according to predefined user interface layouts.
The terminal reduces local processing load by delegating computation-intensive tasks-such as question generation, evaluation, related term extraction, and recommendation—to the server. The terminal instead focuses on efficient rendering and event handling, such as tracking user operation information and stay time information. The terminal may, for example, measure the time between the moment a question appears on the screen and the moment the user submits an answer, and send this measurement to the server as part of interaction logs. By implementing this separation of concerns, the system as a whole attains improved responsiveness on resource-constrained terminals while maintaining sophisticated adaptive logic on the server.
The user interacts with the system by specifying learning target information, such as “quantum mechanics,” “climate change,” or “the French Revolution,” using input controls on the terminal. The user reviews the inquiries, provides textual answers, and examines feedback and recommended content. The user's actions generate data that the server uses to refine understanding-degree indices and interest estimates, which in turn cause prompt sentences to be adjusted. This feedback loop enables the server to provide increasingly tailored inquiry sets, thus improving the precision of understanding-degree measurement and the appropriateness of recommended content.
In an alternative embodiment, the server deploys multiple generative AI models, for example models specialized by domain or by task. The server may use one model for inquiry generation and another model for evaluation and feedback generation. The server stores a model selection table that maps learning target information categories to specific models and constructs prompt sentences accordingly. This modular architecture allows for distributed GPU usage and load balancing, thereby improving overall throughput and reducing average response time.
In another embodiment, the server fine-tunes the generative AI model using domain-specific training data. The server applies a supervised learning procedure in which the model is trained on pairs of prompt sentences and target outputs (for example, sets of high-quality inquiries or expert evaluations). The server defines a loss function, such as a cross-entropy loss between predicted and target token distributions, and updates model weights using gradient descent algorithms with regularization. The server may augment training data by paraphrasing questions, varying difficulty instructions, or injecting controlled noise, thus improving the model's robustness and ability to follow prompt constraints. This training process leads to improved alignment between prompt structures and generated outputs, reducing the need for complex error handling in production.
In yet another embodiment, the server stores a history of prompt sentences and corresponding outputs and uses this history to detect failure patterns, such as repeated formatting deviations.
The server then adapts future prompt sentences by adding explicit constraints or examples.
For example, if the server detects that the model sometimes includes extra commentary in inquiry lists, the server modifies prompt sentences to include a line such as “Do not include any explanation or commentary; output only the questions.” This iterative refinement of prompt design constitutes a non-conventional optimization strategy that enhances the determinism and efficiency of the interaction between the server and the generative AI model.
By structuring data flows, controlling prompt formats, organizing storage schemas, and integrating generative AI computation with deterministic parsing and adaptation logic, the server improves the functioning of the computer system itself. The system thus provides more accurate, scalable, and resource-efficient generation and evaluation of inquiries than conventional approaches, while maintaining a tight mapping between prompt sentences, generated content, user interactions, and stored data structures.

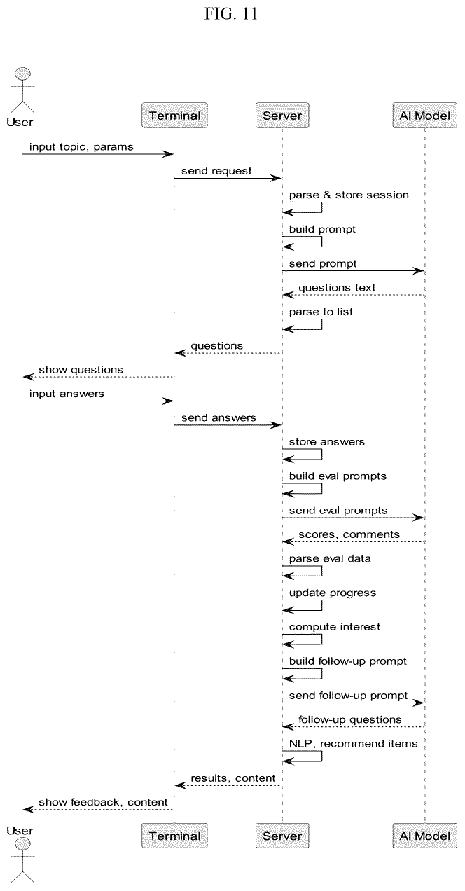

The following describes the processing flow using FIG. 11.

### Step 1:

User inputs learning target information and control parameters.
User operates the terminal to enter a learning target, such as a topic name, into a text input field and optionally selects parameters such as number of questions, language type, and difficulty level. The input of this step is raw user input (keystrokes, selections), and the output is a set of logical values representing the learning target information and control information held in the terminal's memory.

### Step 2:

Terminal formats and transmits learning request data to the server.
Terminal converts the logical values representing the learning target information and control information into a structured learning request data object, for example including fields such as topic string, requested question count, language code, and difficulty label. The input of this step is the internal representation of user input, and the output is a serialized message (e.g., JSON-formatted text) transmitted over a network connection to the server. Terminal uses its communication interface to open a network session and send the serialized message to a predetermined server endpoint.

### Step 3:

Server parses learning request data and stores session metadata.
Server receives the serialized learning request data from the terminal via its network interface and decodes it into an internal data structure. The input of this step is the serialized message received over the network, and the output is an in-memory representation containing fields such as learning target information, control parameters, user identifier, and timestamp. Server validates data types and ranges, assigns a unique session identifier, and writes a record including the session identifier and associated fields into a database table. In this way, server converts unstructured network payloads into structured session metadata records.

### Step 4:

Server generates a prompt sentence for inquiry generation.
Server reads the learning target information and control parameters from the in-memory session structure and applies a string-templating procedure. The input of this step is the set of structured fields (topic, question count, language, difficulty), and the output is a natural-language prompt sentence configured for a generative AI model. Server concatenates fixed template phrases with the variable fields, inserts delimiters such as line breaks, and includes explicit formatting instructions. For example, server generates a prompt sentence such as: “The information that the user wants to learn is ‘quantum mechanics’. Please generate 5 inquiries that measure the user's level of understanding of this information. Each inquiry should be a concise question in English and should focus on a core concept. Return the result as a numbered list of questions, each on a new line, without any additional commentary.”

### Step 5:

Server constructs model call request data and invokes the generative AI model.
Server takes the generated prompt sentence as input and packages it together with generation parameters (e.g., maximum output length, sampling temperature, nucleus sampling parameter) into model call request data. The input of this step is the prompt sentence string and associated numeric configuration values, and the output is a structured request object ready for inference. Server passes this object to a tokenizer, which maps each character sequence in the prompt sentence to a sequence of integer token identifiers. Server then invokes the generative AI model by submitting the token sequence and parameters to a transformer-based neural network running on a GPU. The generative AI model performs matrix multiplications and attention-weight calculations across multiple layers, and produces an output token sequence that the server will later decode.

### Step 6:

Server decodes model output and obtains inquiry generation result data.
Server receives the output token sequence from the generative AI model as a series of integer identifiers. The input of this step is the token sequence produced by the model, and the output is a text string representing the model's generated result. Server uses the tokenizer's vocabulary mapping to convert each token identifier back into its corresponding text fragment and concatenates these fragments into a continuous string. Server stores the resulting text as inquiry generation result data associated with the session identifier, and keeps it in memory for further parsing.

### Step 7:

Server parses inquiry generation result data into structured inquiry information.
Server takes the raw text output containing multiple inquiries as input and processes it using text-splitting and normalization algorithms. The input of this step is the inquiry generation result data string, and the output is a list of inquiry records. Server splits the string at newline characters to obtain candidate lines, removes empty lines, and strips leading numbering tokens (such as “1.” or “2)”) by applying pattern-matching functions. Server trims extra whitespace and checks that each remaining line meets minimum length criteria. For each valid line, server creates an inquiry record with fields such as inquiry text, index number, and language code. Server then writes these records into an inquiry table in the database, associating each record with the session identifier.

### Step 8:

Server transmits structured inquiry information to the terminal.
Server retrieves the newly stored inquiry records from the database, converts them into a structured response object, and serializes this object for transmission. The input of this step is the internal list of inquiry records linked to the session identifier, and the output is a network response message containing inquiry information in a format suitable for the terminal. Server uses its network interface to send the serialized inquiry list to the terminal endpoint that initiated the request.

### Step 9:

Terminal receives and displays inquiries to the user.
Terminal receives the response message from the server via its communication interface and decodes it into an internal list of inquiry items. The input of this step is the serialized inquiry information from the network, and the output is a set of UI elements rendered on the terminal's display. Terminal iterates through the list, creates a visual component for each inquiry (including the inquiry text and an answer input area), and arranges the components in a scrollable view. Terminal may also start timers or event listeners to measure how long each inquiry remains on screen.

### Step 10:

User enters answers to inquiries.
User reads each inquiry on the terminal and enters answer text using an input device such as a keyboard or touch interface. The input of this step is the displayed inquiry text and the user's cognitive response, and the output is a set of textual answer strings maintained in the terminal's memory. User can edit, delete, or confirm answers before submission.

### Step 11:

Terminal formats and transmits user answer data to the server.
Terminal collects the answer strings along with the identifiers or indices of the corresponding inquiries. The input of this step is the internal representation of user-entered answers and associated inquiry identifiers, and the output is a structured user answer data message transmitted to the server. Terminal may include additional fields such as timestamps and dwell times for each inquiry. Terminal serializes this composite data structure and sends it to a designated answer-processing endpoint on the server.

### Step 12:

Server stores user answer data and prepares evaluation prompts.
Server receives the user answer data from the terminal and parses it into internal structures. The input of this step is the serialized answer message, and the output is a set of stored answer records and a set of evaluation-oriented prompt sentences. Server writes each answer into a database table, linking it with the corresponding inquiry record and session identifier. For each inquiry-answer pair, server generates a prompt sentence that embeds the question and the user's answer in a fixed evaluation template, for example:
“You are an expert tutor. Here is a question and a student's answer.
Question: ‘<inquiry text>’
Student answer: ‘<answer text>’
Please evaluate the correctness on a scale from 1 to 5 and provide a brief explanation in 2 to 3 sentences. Return your result in the following format: ‘Score: <number>’ on the first line and ‘Comment: <text>’ on the second line.”
Server stores these evaluation prompts in memory for use in the next step.

### Step 13:

Server invokes the generative AI model for understanding-degree evaluation.
Server takes each evaluation prompt sentence as input and constructs corresponding model call request data as in earlier steps. The input of this step is the set of evaluation prompt sentences and configuration parameters, and the output is a set of model output strings containing scores and comments. Server tokenizes each prompt, executes forward passes through the generative AI model, and decodes the output token sequences into text. Server aggregates the resulting text outputs as evaluation result data tied to the original inquiries and answers.

### Step 14:

Server parses evaluation result data into understanding-degree indices and explanation information.
Server reads the evaluation result text strings and applies pattern-based extraction to obtain numeric scores and comments. The input of this step is the evaluation result data text, and the output is a structured set of understanding-degree indices and explanation information records. Server locates substrings starting with labels such as “Score:” and “Comment:”, parses the integer following the score label, and extracts the comment text. Server validates that the score lies within an expected range and truncates comments that exceed a maximum length. Server writes these indices and explanation texts into database tables that link to the session, inquiry, and answer records.

### Step 15:

Server computes learning progress information from historical indices.
Server queries the database for understanding-degree indices associated with the current session and, optionally, with past sessions for the same user or topic. The input of this step is the set of stored indices retrieved via database queries, and the output is an aggregated learning progress information record. Server performs numerical operations such as averaging, weighting by difficulty, and computing trend metrics (e.g., improvement over time) using numeric libraries or database functions. Server then stores the computed learning progress metrics in a dedicated table for later reference.

### Step 16:

Server estimates degree of user interest from interaction logs.
Server receives user operation information and stay time information from the terminal and stores them in an interaction log table. The input of this step is the interaction event data and dwell-time measurements, and the output is a numeric or categorical degree-of-interest value.
Server calculates features such as average dwell time per inquiry, number of revisits to particular questions, and frequency of interaction events. Server normalizes these features and applies a heuristic or learned mapping function to produce an interest score. This interest score is stored and used as input to further adaptation logic.

### Step 17:

Server generates adaptive prompt sentences for additional or follow-up inquiries.
Server takes as input the learning progress information and the degree of user interest, along with the original learning target information. The output of this step is a set of new prompt sentences designed to produce additional or follow-up inquiries tailored to the user's state.
Server determines adaptation rules such as increasing difficulty when both understanding-degree indices and interest are high, or narrowing the scope to basic concepts when understanding is low. Server encodes these rules into natural language instructions within the prompt, for example by specifying: “focus on introductory concepts,” “generate more application-oriented questions,” or “address common misconceptions identified in previous answers.” The resulting adaptive prompt sentences are then used to call the generative AI model again, following the same tokenization and inference procedures as in earlier steps.

### Step 18:

Server extracts related terms and selects related content candidates.
Server uses the learning target information, inquiry texts, user answers, and explanation information as input to a natural language processing program. The input of this step is a collection of text fields associated with the user's session, and the output is a list of related terms, peripheral fields, and ranked related content candidates. Server tokenizes the texts, computes term frequencies, and generates embedding vectors for terms and content metadata.
Server calculates similarity scores between extracted terms and stored content descriptors, and selects items such as books, videos, or other digital resources whose similarity exceeds a threshold. Server assembles these items into related content presentation information.

### Step 19:

Server transmits evaluation results, learning progress, and related content information to the terminal.
Server composes a response object that includes understanding-degree indices, explanation information, learning progress information, and related content presentation information. The input of this step is the structured data stored in various database tables for the current session, and the output is a serialized message sent to the terminal. Server uses its network interface to transmit this message and may compress or otherwise optimize the data to reduce communication load.

### Step 20:

Terminal displays feedback and related content to the user.
Terminal receives the server's response message via its communication interface and parses it into internal data structures. The input of this step is the serialized evaluation and recommendation data, and the output is an updated user interface presenting scores, explanatory comments, summary progress indicators, and related content suggestions.
Terminal renders visual elements such as score labels, colored progress bars, and clickable content cards. Terminal also continues to monitor user interactions and dwell times for these views, producing new interaction data that will be used as input to subsequent iterations of the process.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems typically present static, pre-authored questions and content that are only coarsely aligned with a learner's current knowledge and emotional state. In such systems, a processor often selects questions from a fixed item bank or simple rules, without dynamically analyzing the semantic content of user inputs or adapting subsequent questions at a fine-grained concept level. As a result, the system is unable to efficiently localize weak concepts, generate targeted follow-up questions in real time, or provide feedback and content that are tightly coupled to the user's evolving understanding.

Furthermore, many existing systems treat assessment, feedback generation, and content recommendation as separate, loosely integrated modules. A typical implementation may evaluate responses with hard-coded scoring logic and may then recommend generic resources, without using a unified generative artificial intelligence model to (i) generate the assessment items, (ii) evaluate the user's answers, and (iii) synthesize personalized feedback and follow-up content from a common representation of the user's knowledge state. This fragmented architecture increases processing complexity, requires manual content maintenance, and restricts the system's ability to scale across diverse domains.
In addition, conventional systems generally fail to incorporate a model of the user's emotional state into the core content generation pipeline. Even when a system logs user behavior, it frequently does not translate this behavior into explicit emotional state estimates that directly control the generation or modification of prompt sentences for a generative artificial intelligence model. Consequently, the system cannot dynamically adjust question difficulty, tone, or presentation style in a manner that stabilizes user engagement and reduces cognitive overload, leading to suboptimal learning efficiency and poor user experience.
From a computer-technology standpoint, there remains a need for an improved information processing architecture that programmatically transforms user input text, response data, and behavior logs into structured semantic and affective states, and that uses these states to synthesize tightly specified prompt sentences for a generative artificial intelligence model.
Such an architecture should integrate natural language processing, machine-learned evaluation, and emotional-state estimation into a coherent control loop that (i) generates questions, (ii) evaluates answers, and (iii) determines and generates follow-up content, all in a dynamic and automated manner. This can improve the functioning of the computer system itself by reducing manual authoring, decreasing redundant data transfers between disparate modules, and enabling more efficient use of computation for adaptive learning tasks.
Accordingly, there is a need for a system and method in which a processor automatically analyzes learning targets and user responses, computes an understanding index and weak concepts, estimates the user's emotional state based on response and behavior history data, and generates precise prompt sentences that direct a generative artificial intelligence model to output questions, evaluations, feedback, and content that are continuously adapted to the user's understanding and emotions. This technological improvement enables more effective and efficient computer-based learning interactions than those achievable with conventional static or rule-only systems.

The specific processing by the specific processing unit 290 of the data processing device 12 in Application Example 1 is realized by the following means.

The present invention provides a server comprising a processor configured to receive character information indicating a learning target from a user terminal, to analyze the character information by using a natural language processing unit, and to extract a subject and a concept from the character information; to generate a prompt sentence that instructs a generative artificial intelligence model to generate a set of questions for measuring a user's level of understanding based on the extracted subject and concept, to transmit the prompt sentence to the generative artificial intelligence model, and to obtain the set of questions from the generative artificial intelligence model; to transmit the obtained set of questions to the user terminal for display, to receive answer information of the user from the user terminal, to analyze the answer information, and to calculate an evaluation value for each answer and an overall understanding index by using an evaluation rule or a machine learning model; to identify a weak subject or concept based on the calculated understanding index and evaluation results of the answers, and to generate a prompt sentence that instructs the generative artificial intelligence model to generate learning information or problems for reinforcing the weak subject or concept; to estimate an emotional state of the user based on the answer information or behavior history acquired from the user terminal, and to generate a prompt sentence that instructs the generative artificial intelligence model to dynamically change a content or difficulty level of questions and presented content in response to the emotional state and the understanding index; and to obtain feedback information and additional learning information from the generative artificial intelligence model, to transmit the feedback information and the additional learning information to the user terminal, and to cause the user terminal to present the feedback information and the additional learning information so that the user is able to plan a next learning step. This enables an improved computer-implemented learning support system in which the processor transforms raw user input, response data, and behavior logs into structured semantic and affective states that directly control generation of prompt sentences for a generative artificial intelligence model, thereby dynamically generating, evaluating, and adapting questions and content at runtime, reducing reliance on static item banks, increasing processing efficiency, and enhancing personalization and user engagement.

The term “system” refers to a combination of hardware and software components including at least one processor and one or more terminals that cooperate to execute the processing described in the claims.

The term “processor” refers to one or more hardware processing units, such as a central processing unit or an execution core, configured to execute machine-readable instructions to perform the functions described in the claims.
The term “server” refers to an information processing apparatus including the processor, one or more memory devices, and communication interfaces, configured to communicate with one or more user terminals over a communication network.
The term “user terminal” refers to an electronic device operated by a user, such as a portable terminal, a stationary terminal, or a display-equipped communication device, that transmits user input to the server and presents information received from the server.
The term “character information” refers to text data comprising one or more characters or symbols that represent a learning target or other user input in a human-readable language.
The term “learning target” refers to a subject, topic, field, theme, or domain that a user desires to study or for which the user's level of understanding is to be measured.
The term “natural language processing unit” refers to a software-implemented processing module or set of modules executed by the processor to analyze text data in a human language and to extract linguistic features such as tokens, phrases, parts of speech, entities, or semantic relations.
The term “subject” refers to a higher-level theme, field, or area of knowledge extracted from character information, which serves as a main focus of learning or assessment.
The term “concept” refers to a particular notion, idea, term, subtopic, or granular knowledge element that belongs to or is associated with a subject and that may be individually assessed or reinforced.
The term “prompt sentence” refers to text data formatted as an instruction or request, transmitted from the processor to a generative artificial intelligence model, that specifies a task to be performed by the model, such as question generation, answer evaluation, feedback generation, or content generation.
The term “generative artificial intelligence model” refers to a machine-learned model configured to generate output data, including text, in response to input data such as a prompt sentence, by using parameters obtained through training on data sets.
The term “set of questions” refers to a plurality of question items generated by the generative artificial intelligence model, each question item being configured to elicit a response from the user for assessment of understanding of a subject or concept.
The term “answer information” refers to data representing one or more responses provided by the user to the set of questions, including text answers, selected choices, or other input formats.
The term “evaluation rule” refers to one or more predetermined conditions, patterns, or scoring criteria, represented as machine-readable instructions or data structures, that are applied by the processor to compute an evaluation value for a user's answer.
The term “machine learning model” refers to a trained computational model, other than the generative artificial intelligence model used for content generation, that receives input data and outputs an evaluation, score, classification, or prediction based on parameters learned from training data.
The term “evaluation value” refers to a numerical value, label, or score computed for an individual user answer, indicating a degree of correctness, completeness, or quality of the answer.
The term “understanding index” refers to an aggregated metric derived from a plurality of evaluation values corresponding to multiple answers, indicating an overall level of the user's understanding for one or more subjects or concepts.
The term “weak subject or concept” refers to a subject or concept that is determined, based on the understanding index or evaluation values, to be insufficiently understood by the user relative to one or more thresholds or criteria.
The term “learning information” refers to instructional content, such as explanations, examples, practice problems, or summaries, that is intended to improve the user's understanding of a subject or concept.
The term “problem” refers to a question, exercise, or task, including a newly generated question item, presented for the purpose of practicing or assessing knowledge of a subject or concept.
The term “behavior history” refers to data representing one or more past interactions of the user with the system, including operation logs, response times, navigation events, content selections, or other observable behaviors.
The term “emotional state” refers to a state representing an inferred affective condition of the user, such as frustration, boredom, engagement, or confidence, estimated based on answer information, behavior history, or other observable indicators.
The term “content” refers to information presented to the user, including but not limited to learning content, assessment content, feedback messages, or entertainment content, in textual, graphical, auditory, or mixed-media form.
The term “difficulty level” refers to a measure or classification indicating how challenging a question or content item is intended to be for a user, relative to other questions or content items.
The term “presentation order” refers to a sequence or arrangement in which multiple content items, including questions or learning materials, are provided to the user over time.
The term “feedback information” refers to information generated for the user based on evaluation of the user's answers, including comments, explanations, encouragement, or guidance on how to improve understanding.
The term “additional learning information” refers to further learning information, follow-up problems, or recommended topics that are generated or selected after initial evaluation, for the purpose of deepening the user's understanding.
The term “operation history information” refers to behavior history data specifically representing user operations, such as button presses, scrolling actions, content selections, and session durations, recorded by the user terminal or the server.
The term “learning content” refers to a subset of content that is primarily intended for educational purposes, such as instructional text, tutorials, interactive exercises, or explanatory media.
The term “entertainment content” refers to a subset of content that is primarily intended for amusement or engagement, such as gamified quizzes, stories, or media elements, which may nonetheless support learning.

In one embodiment, a server cooperates with one or more terminals operated by users to implement the claimed system. The server includes at least one processor, a main memory, a non-volatile storage device, and a network interface. The processor may be realized by a general-purpose central processing unit, a graphics processing unit, or a combination thereof. The memory stores program modules that, when executed by the processor, realize a natural language processing unit, a prompt sentence generation unit, an evaluation unit, an emotional state estimation unit, and a content control unit. The non-volatile storage stores trained model parameters for a generative AI model and auxiliary machine learning models. The network interface enables bi-directional communication with terminals via a packet-switched network.

The terminal is, for example, a smartphone, a tablet, or a personal computer equipped with a display, an input device such as a touch panel or keyboard, a communication interface, and a local memory. The terminal executes a client application or a browser-based application to present user interfaces, to transmit user input, and to receive and display questions, feedback, and content output by the server. The user operates the terminal to input a learning target, answer questions, and select recommended content.
The server stores program modules in the memory as executable instructions. These program modules are generated using a programming language such as a high-level language and compiled or interpreted to run on an operating system installed on the server. The natural language processing unit is implemented as a software module that uses an NLP library (for example, a library equivalent to spaCy) to perform tokenization, part-of-speech tagging, dependency parsing, and named entity recognition on character information representing a learning target. The natural language processing unit outputs internal data structures, such as lists of tokens, part-of-speech tags, dependency trees, and named entity spans. The server further stores a mapping table or ontology in the storage that associates terms and phrases with higher-level subjects and concepts. The natural language processing unit uses this mapping to transform extracted entities into normalized subjects and concepts.
The server implements the generative AI model as a trained neural network model stored in the storage and loaded into memory. In one embodiment, the generative AI model is a transformer-based auto-regressive language model including a plurality of layers, each layer comprising a multi-head self-attention sub-layer and a position-wise feed-forward sub-layer.
The model stores weight matrices and bias parameters for attention projections and feed-forward transformations, trained on large-scale text corpora. The server executes a model inference engine that, given a prompt sentence as input token sequence, computes intermediate representations by matrix multiplications, non-linear activation functions, and normalization operations, and outputs probability distributions over vocabulary tokens for each position, thereby generating text tokens sequentially.
The server further implements auxiliary machine learning models for evaluation and emotional state estimation. In one embodiment, the server uses a recurrent neural network or a smaller transformer model as an evaluation model to compute a semantic similarity score between a user answer and a reference answer. The evaluation model is trained on pairs of questions and answers with labeled scores, using a loss function such as mean squared error or cross-entropy to update weights via gradient descent. The emotional state estimation unit uses a classification model, such as a neural network or gradient boosting model, that receives features derived from user behavior history (response time distribution, number of skipped questions, number of session interruptions) and textual features of answers (sentiment scores, presence of specific affective words) and outputs an estimated emotional label or a continuous engagement score.
The server uses specific data structures in memory to manage user sessions. For each session, the server stores a record comprising: a user identifier, a session identifier, the current learning target as normalized subject and concepts, the set of generated questions with unique question identifiers, the received answers, per-question evaluation values, an aggregated understanding index, a list of weak concepts, a current emotional state estimate, and a history of prompt sentences issued to the generative AI model. By maintaining these structured records, the server can reuse context and reduce redundant data lookups and model calls, improving processing efficiency.
The server generates prompt sentences as plain text strings following templates stored in the storage. The prompt generation unit fills template slots using the subjects, concepts, user scores, and emotional states stored in the session record. For example, for initial question generation, the server uses a template such as:
“Please generate 5 questions to measure the user's understanding of the basics of [SUBJECT]. The questions should cover the following concepts: [CONCEPT_LIST]. The questions should be suitable for a beginner.”
The server replaces [SUBJECT] with a normalized subject, and [CONCEPT_LIST] with a comma-separated list of concepts extracted by the natural language processing unit. In another example, for a more concise prompt, the server uses:
“Please generate 5 questions to measure the user's understanding of quantum physics.”
For feedback generation, the server uses a template such as:
“The user answered a quiz on [SUBJECT] with an overall score of [SCORE] percent. The user's strengths are [STRONG_CONCEPTS]. The user's weaknesses are
[WEAK_CONCEPTS]. Please generate a short, encouraging feedback message and suggest 3 specific subtopics or resources the user should study next.”
For emotional adaptation, the server uses a template such as:
“The user is currently [EMOTIONAL_STATE], with an understanding level of
[UNDERSTANDING_INDEX] on [SUBJECT]. Please generate 3 questions with
[DIFFICULTY_LEVEL] difficulty and a supportive tone, focusing on

### [WEAK_CONCEPTS].”

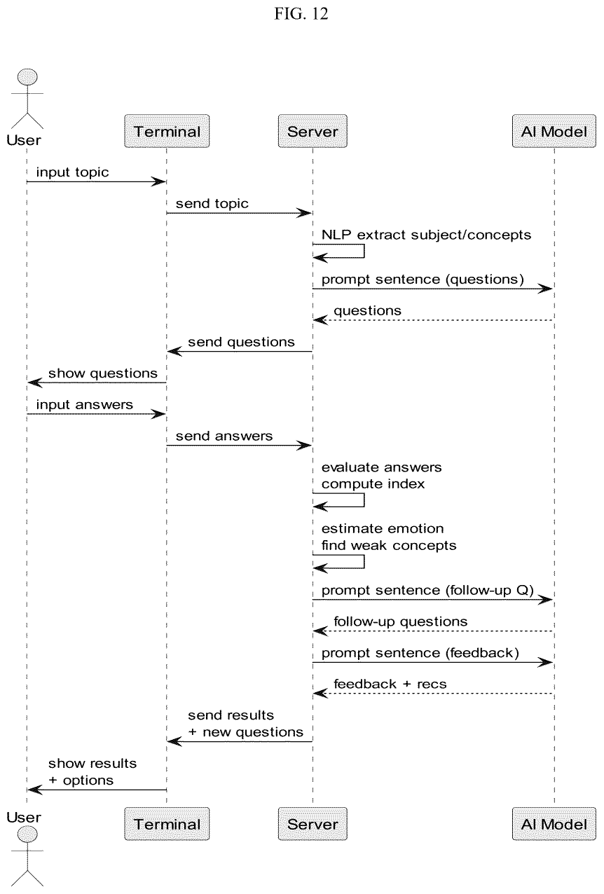

The server transmits these prompt sentences to the generative AI model inference engine, which encodes the character sequences into token identifiers using a tokenizer. The model then processes the token sequences through attention and feed-forward layers, applying learned weight matrices and non-linear activations. The model selects output tokens based on probability thresholds or sampling strategies such as top-k or nucleus sampling. The server decodes the token sequences into text strings, separates the generated text into individual questions or feedback segments according to delimiters (line breaks, numbering, or specified separators), and stores the results in the session record.
The server applies specific algorithms to evaluate user answers. When the answers are short factual responses, the server compares tokenized answer text to reference answer token sets and computes overlap and synonym matches using a lexical database or an embedding-based similarity measure. The server uses this comparison to compute evaluation values according to a scoring rule, for example assigning a full score if the similarity exceeds a threshold and a partial score if the similarity is within a specified range. When answers are long or open-ended, the server uses the evaluation model to embed the answer and the reference answer into vector representations and then computes cosine similarity. The server then maps this similarity to an evaluation value by applying a monotonic function defined in configuration data.
The server computes an understanding index by aggregating per-question evaluation values using a weighted average. The weights may depend on question difficulty, which is stored in metadata or inferred from model output. The server identifies weak concepts by associating each question with one or more concepts and accumulating scores per concept. If a concept's aggregated score falls below a threshold or below a certain percentile of all concept scores, the server marks the concept as weak and records it in the session record. This concept-level aggregation enables the server to localize knowledge gaps beyond simple question-level scoring.
The server estimates the user's emotional state using features not readily accessible to a human instructor in real time. For example, the server computes response time statistics across questions, such as average, variance, and trends, and encodes answer correctness sequences as binary strings. The emotional state estimation model receives these numeric features along with textual sentiment features extracted from answers, such as polarity and subjectivity scores. By training this model on labeled interaction logs, the server learns non-obvious patterns linking behavioral features to emotional states. The server then uses the predicted emotional state to modify template selection and prompt content, such as lowering difficulty and adding encouragement when the state suggests frustration, or increasing challenge when the state suggests boredom. This non-conventional use of emotional inference to directly control generative model inputs improves learning engagement and reduces drop-out.
The server reduces communication overhead and latency by bundling multiple operations into a single call to the generative AI model when feasible. For example, the server can generate both questions and corresponding reference answers in a single prompt, or obtain feedback and follow-up recommendations in a single response. The server stores the generated reference answers locally and avoids repeated calls for the same questions in the same or later sessions. This design reduces the number of remote model invocations and therefore reduces network traffic and processing time.
The server improves memory usage and computational efficiency by caching intermediate representations and using shared embeddings where possible. For example, when the same subject and concepts recur for multiple users, the server can reuse previously generated question sets and only adapt difficulty and tone via shorter prompts. This reuse reduces the amount of inference computation required and enables the server to support more concurrent sessions with the same hardware resources.
The server does not merely automate human tasks, but implements specific rules and algorithms that are not practical for manual execution. For instance, the server continuously maintains a multi-dimensional profile of each user, including per-concept scores, emotional state trajectories, and prompt history. Using this profile, the server selects among different prompt templates and parameters according to machine-readable rules. The server can apply a non-linear control policy that increases question difficulty when both understanding index and engagement are rising, and decreases difficulty when understanding index is low and emotional state suggests frustration. Such dynamic control, computed on a question-by-question basis using numeric thresholds and machine-learning-based predictions, constitutes an improvement in adaptive control of computer-implemented educational processes.
The server can employ alternative architectures for the generative AI model. In one alternative embodiment, the server uses an encoder-decoder architecture in which an encoder network first computes a fixed-length representation of the prompt sentence, and a decoder network then generates the output sequence conditioned on that representation. In another alternative embodiment, the server uses a mixture-of-experts model where different expert subnetworks specialize in different content types, such as question generation, explanation generation, or summary generation, and a gating network selects or weights experts based on the prompt features.
The server can also vary the training and learning methods of the models. In one embodiment, the generative AI model and evaluation models are trained using supervised learning on labeled text pairs. In another embodiment, the server fine-tunes the generative AI model online or periodically using anonymized interaction logs, adjusting weights by minimizing a loss function that measures discrepancy between generated content and user performance or satisfaction metrics. The server can augment training data by data augmentation techniques such as paraphrasing, synonym replacement, and back-translation, which increase robustness and reduce overfitting. The server stores updated parameters in the storage and loads them at predetermined intervals, thereby improving accuracy and relevance over time without manual re-authoring.
The server further improves data management by standardizing all session and content information into a normalized schema. For example, every question, answer, concept, and content item is assigned a globally unique identifier, and relationships among them are represented in relational tables or graph structures. This structured representation enables efficient queries to retrieve all questions linked to a specific concept, to compute cross-session statistics, and to support recommendation algorithms. The server can index these identifiers and associated features, thus accelerating evaluation and recommendation processes and reducing response time for the user.
The terminal, in cooperation with the server, contributes to technical improvements by offloading heavy computation to the server while locally handling user interface rendering and basic validation. The terminal formats display data in a way that reduces the amount of transferred data; for example, the server sends compact identifiers and short textual fields instead of full multimedia content when not necessary. The terminal requests additional content only when the user selects it, thereby reducing unnecessary traffic and conserving bandwidth. The terminal can also cache previously received questions and feedback to support offline review and to decrease repeated network requests.
The user benefits from these technical improvements through a more responsive and personalized experience. The user receives questions that are not only semantically aligned with the declared learning target but also dynamically adapted based on detailed concept-level assessment and emotional state estimation. The user receives feedback and additional learning information that the server generates via prompt sentences, such as: “Based on the user's answers, the user understands quantum superposition and the double-slit experiment well but is uncertain about quantum entanglement. Please generate a concise explanation of quantum entanglement with one simple analogy and 3 short practice questions.”
By using these prompt sentences, the server obtains content that directly addresses specific weaknesses, without requiring manual preparation of materials for each possible combination of concepts and emotional states.
In summary, the server, terminal, and user cooperate in a system where the server's processor transforms raw textual input, behavior logs, and answer data into structured semantic and affective states and then uses these states to synthesize prompt sentences for a generative AI model. The server thus drives the generative AI model to generate questions, evaluations, and content in a tightly controlled, technically structured manner. This configuration improves processing speed, evaluation accuracy, data management, and communication efficiency, and provides a non-conventional computer-based solution that extends beyond mere automation of human educational tasks.
The following describes the processing flow using FIG. 12.

### Step 1:

The user operates the terminal to start a learning session and to input a learning target. The terminal displays a text input field on a screen and captures key or touch events from the user.
Input: raw keystrokes or touch events from the user.
Output: a character string representing the learning target (for example, “I want to learn the basics of quantum physics.”) stored in the terminal's memory.

### Step 2:

The terminal converts the character string into a request payload and transmits it to the server.
The terminal serializes the string into a structured message and sends it via a communication interface over a network.
Input: the character string representing the learning target.
Output: a network message containing the learning target, addressed to the server.

### Step 3:

The server receives the network message and stores the learning target in a session record.
The server parses the message, validates that the learning target field is present, and associates it with a user identifier and a new session identifier.
Input: the network message from the terminal including the learning target.
Output: a session record in server memory or storage containing the user identifier, session identifier, and raw learning target text.

### Step 4:

The server analyzes the learning target using a natural language processing unit. The server passes the raw text into a language model that performs tokenization, part-of-speech tagging, and entity extraction to identify subjects and concepts.
Input: the raw learning target text from the session record.
Output: a structured representation including a subject (for example, “quantum physics”) and a set of concepts (for example, “quantum superposition,” “quantum entanglement,” “double-slit experiment”) stored in the session record.

### Step 5:

The server generates an initial prompt sentence for question generation based on the extracted subject and concepts. The server selects a template and fills placeholder fields with the subject and concepts, then formats the prompt sentence as plain text.
Input: the subject and concept set from the structured representation.
Output: a prompt sentence text, for example, “Please generate 5 questions to measure the user's understanding of the basics of quantum physics. The questions should cover the following concepts: quantum superposition, quantum entanglement, double-slit experiment.”

### Step 6:

The server transmits the prompt sentence to a generative AI model and obtains a generated set of questions. The server encodes the prompt sentence into tokens, passes the tokens through the generative AI model, and decodes the resulting token sequence into text.
Input: the prompt sentence for question generation.
Output: a text block containing multiple questions, then a parsed set of individual questions each with an internal identifier, stored in the session record.

### Step 7:

The server sends the generated questions to the terminal for presentation. The server packages the questions into a response message and transmits it via the network interface.
Input: the set of questions with identifiers from the session record.
Output: a network message to the terminal containing the list of questions and associated identifiers.

### Step 8:

The terminal receives the questions and renders them on a display. The terminal parses the message, creates visual elements for each question, and allocates input fields for user answers.
Input: the network message containing the list of questions.
Output: a graphical user interface on the terminal that shows the questions and provides answer input controls.

### Step 9:

The user reads the questions and enters answers on the terminal. The user interacts with the input controls to type text or select options. The terminal captures the input per question and binds each answer to a question identifier.
Input: user touches or keystrokes on the question interface.
Output: structured answer data in the terminal memory, linking each question identifier to a corresponding answer string or selected option.

### Step 10:

The terminal transmits the structured answer data to the server. The terminal serializes the answers and associated identifiers into a message and sends it via the communication interface.
Input: the structured answer data generated from user input.
Output: a network message containing the answer information and the session identifier, addressed to the server.

### Step 11:

The server receives the answer information and stores it in the session record. The server parses the message, validates question identifiers, and writes each answer and its metadata into persistent storage.
Input: the network message containing the structured answer data.
Output: updated session data including user answers linked to question identifiers and concepts.

### Step 12:

The server evaluates each answer using rule-based logic and machine learning models. The server retrieves reference answers or concept descriptions, extracts features from the user answers, and computes evaluation values.

Input: user answers, reference answers, and concept mappings from storage.

Output: per-answer evaluation values (for example, numerical scores) and correctness labels stored in the session record.

### Step 13:

The server computes an overall understanding index and identifies weak concepts. The server aggregates per-answer scores by concept, applies weighting rules, and compares aggregated scores to thresholds.
Input: per-answer evaluation values and question-to-concept associations.
Output: a numerical understanding index for the learning target and a list of weak concepts whose scores fall below specified criteria, written into the session record.

### Step 14:

The server analyzes behavior history and answer patterns to estimate an emotional state. The server derives features such as response times, sequence of correct and incorrect answers, and sentiment indicators from answer text, then inputs these features into an emotional state model.
Input: temporal answer data, correctness sequence, and textual features derived from answers.
Output: an estimated emotional state label or engagement score associated with the current session and stored in the session record.

### Step 15:

The server generates a prompt sentence for targeted follow-up questions based on weak concepts and emotional state. The server selects a template that encodes difficulty and tone and fills it with the weak concept list and emotional state information.
Input: weak concept list, understanding index, and emotional state from the session record.
Output: a prompt sentence such as “The user is currently frustrated and has a low understanding of quantum entanglement. Please generate 3 easy questions with a supportive tone focusing on quantum entanglement.”

### Step 16:

The server transmits the follow-up prompt sentence to the generative AI model and obtains additional questions. The server encodes the prompt, performs inference, and decodes the output to obtain new question texts.
Input: the follow-up prompt sentence for additional question generation.
Output: a set of additional questions tailored to the weak concepts and emotional state, stored in the session record.

### Step 17:

The server generates a prompt sentence for feedback and recommendations using the understanding index, strong and weak concepts, and emotional state. The server fills another template that requests feedback text and recommended topics.
Input: understanding index, lists of strong and weak concepts, and emotional state.
Output: a feedback prompt sentence such as “The user answered a quiz on quantum physics with an overall score of 80%. The user's strengths are quantum superposition and the double-slit experiment. The user's weakness is quantum entanglement. Please generate a short, encouraging feedback message and suggest 3 specific subtopics the user should study next.”

### Step 18:

The server transmits the feedback prompt sentence to the generative AI model and obtains feedback information and recommendations. The server processes the generated text to separate a feedback message and a list of suggested subtopics.
Input: the feedback prompt sentence.
Output: structured feedback information including a feedback message text and recommended subtopics, stored in the session record.

### Step 19:

The server composes a response containing evaluation results, feedback, and any additional questions or learning content. The server selects data from the session record and arranges it into a structured form suitable for transmission.
Input: understanding index, per-question evaluation values, additional questions, and feedback information.
Output: a network message to the terminal containing scores, feedback text, lists of weak concepts, and any follow-up questions or recommended topics.

### Step 20:

The terminal receives the response and updates the user interface to display results and suggestions. The terminal parses the message, renders scores as numeric values or visual indicators, shows the feedback message, and presents additional questions or recommended topics as selectable elements.
Input: the network message containing evaluation results and feedback.
Output: an updated graphical display that conveys understanding level, feedback, and next-step options to the user.

### Step 21:

The user reviews the displayed information and decides on a next learning action. The user may select a recommended topic, start additional questions, or end the session. The terminal captures the user's choice as new input for the system.
Input: visual feedback and interactive elements presented on the terminal screen; user selection or command.
Output: new session control data, such as a selected topic or a request for a new quiz, to be sent to the server for subsequent processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented information provision systems that utilize question-and-answer flows, a processor typically performs static matching between user input and pre-authored content. Such systems often rely on fixed decision trees or manually designed rule sets to select questions and related content. As a result, the systems encounter several technical problems.

First, the processor is not configured to dynamically adapt the content selection logic at run time based on a fine-grained evaluation of a user's understanding level and emotional state.
The underlying computation generally treats input text as simple keywords or short patterns, which limits the ability of the system to accurately model the user's current knowledge state.
This causes inefficiencies in memory access and network usage, because redundant or inappropriate content is repeatedly retrieved and transmitted.
Second, existing systems do not effectively leverage generative AI models as core computational components that can be orchestrated through prompt sentences generated by the system itself. In many cases, a generative AI model is called in an ad hoc manner, with hard-coded prompts, and without a structured feedback loop based on prior user answers, database search results, and emotional analysis. This results in a fragmented processing pipeline in which the processor cannot systematically control, optimize, and reuse inference results. Consequently, the system cannot efficiently integrate model outputs with database queries to construct coherent, context-aware information sets.
Third, there is a technical deficiency in how related information and surrounding information are organized and presented. Conventional systems often perform simple ranking or filtering of search results, without restructuring the information according to dynamically generated topic structures derived from the user's answers. The processor is not configured to map model-generated topics onto an internal classification structure of an information storage device, which leads to suboptimal data organization, inefficient retrieval paths, and user interfaces that do not exploit the full structure of the stored information.
Fourth, existing architectures generally do not maintain a time-series model of a user's evolving understanding level and interest. The processor typically processes each interaction independently, without tracking changes across multiple sessions. This prevents the system from optimizing subsequent question generation and content selection based on historical signals, and it leads to repeated or poorly sequenced content delivery, which wastes computational resources and network bandwidth.
Accordingly, there is a need for a computer-implemented system in which a processor actively generates and updates prompt sentences to control a generative AI model, analyzes user answers in conjunction with stored information resources, estimates a user's emotional state, and restructures related and surrounding information for adaptive presentation. By integrating these functions into a coherent processing pipeline, the underlying computer technology-specifically, the mechanisms for text analysis, information retrieval, content structuring, and interactive presentation—can be improved in terms of processing efficiency, adaptability, and effective utilization of computational resources.

The specific processing by the specific processing unit 290 of the data processing device 12 in Example 2 is realized by the following means.

The present invention provides a server comprising a processor configured to generate, based on target information acquired from a terminal and answer information from a user regarding the target information, a prompt sentence that instructs a generative AI model to evaluate a degree of understanding of the user with respect to the target information and to generate question information according to the degree of understanding; to analyze the answer information by supplying the answer information to the generative AI model using the prompt sentence, to extract one or more topics related to the target information based on an analysis result, and to search, using the extracted topics, information resources stored in an information storage device; to generate a prompt sentence that instructs the generative AI model to generate related information that deepens the understanding of the target information and surrounding information that expands an interest of the user away from the target information, the prompt sentence being based on the answer information and the extracted topics, and to integrate a generation result from the generative AI model and a search result of the information resources to produce presentation information for output to the terminal; and to estimate an emotional state of the user based on expressions included in the answer information and to generate a prompt sentence that instructs the generative AI model to dynamically adjust a difficulty level and a detail level of question information or content information to be presented, based on the emotional state and the degree of understanding. This enables the underlying computer system to dynamically control and orchestrate generative AI inference, database retrieval, and information restructuring in a unified processing pipeline, thereby improving the efficiency and adaptability of text analysis and content delivery operations, reducing redundant data transmissions, optimizing memory and processor utilization, and providing technically enhanced, context-aware information presentation to the user.

The term “system” refers to an information processing arrangement including at least one processor and one or more storage devices, which cooperate to execute computer-readable instructions to perform the claimed functions.
The term “processor” refers to one or more hardware processing units, such as a central processing unit or a graphics processing unit, configured to execute instructions and perform arithmetic and logical operations to implement the claimed functions.
The term “terminal” refers to an information processing apparatus, such as a portable device, a stationary device, or a display device, configured to transmit data to and receive data from the system and to present information to a user.
The term “target information” refers to information that is a subject of evaluation or learning for the user, including, for example, a topic, a document, or a content item that the system uses as a basis for generating questions and related information.
The term “user” refers to a person or an entity that interacts with the system through the terminal by providing input and receiving output.
The term “answer information” refers to text or other data representing a response provided by the user with respect to the target information or a question about the target information.
The term “degree of understanding” refers to a level or measure that indicates how well the user comprehends the target information, which is inferred or evaluated by the system based on the answer information and model outputs.
The term “question information” refers to data representing one or more questions generated or selected by the system for presentation to the user in order to assess or improve the user's understanding of the target information.
The term “content information” refers to data representing explanatory texts, examples, documents, or other materials that are presented to the user to support understanding or exploration of the target information.
The term “prompt sentence” refers to a text sequence or structured input that is generated by the processor and supplied to a generative AI model to instruct the model to perform a specified operation, such as evaluation, topic extraction, or content generation.
The term “generative AI model” refers to a machine learning model configured to generate output data, such as natural language text, in response to input data including a prompt sentence, by performing inference based on parameters learned from training data.
The term “analysis result” refers to data derived from processing the answer information by the generative AI model or by the processor, including, for example, extracted topics, inferred understanding levels, or other interpreted features.
The term “topic” refers to a concept, subject, or thematic label extracted or generated by the system to represent content related to the target information or the user's answer.
The term “related information” refers to information that is directly associated with the target information or the extracted topics and that contributes to deepening the user's understanding of the target information.
The term “surrounding information” refers to information that is not directly focused on the target information but is associated with adjacent or broader topics, and that is intended to expand the user's interest.
The term “information storage device” refers to a storage component, such as a memory device or a storage medium, configured to store information resources, classification information, and other data used by the system.
The term “information resource” refers to a stored data item, such as a record, a document, or a content item, that can be retrieved from the information storage device based on queries involving the extracted topics or other parameters.
The term “presentation information” refers to processed and formatted data generated by the processor, including related information and surrounding information, which is intended for display or output at the terminal.
The term “emotional state” refers to a condition or characteristic of the user's emotion, such as interest, confusion, or frustration, inferred by the system from the answer information or other user inputs.
The term “difficulty level” refers to a measure of complexity or sophistication of question information or content information that is adjusted by the system according to the user's degree of understanding and emotional state.
The term “detail level” refers to a measure of granularity or amount of explanatory information contained in question information or content information that is adjusted by the system according to the user's degree of understanding and emotional state.
The term “classification information” refers to category data, labels, or structural information associated with information resources in the information storage device, used to organize, group, or index those resources.
The term “topic group” refers to a set of one or more topics or topic-related items that are grouped together for presentation or processing based on classification information or restructuring operations.
The term “restructuring” refers to a process of reorganizing model-generated related information and surrounding information in association with classification information of information resources, to control display order, grouping, or other structural aspects of the information presented to the user.

In one embodiment, a server implements the claimed system by executing a program on a hardware platform including at least one central processing unit, at least one memory device, a persistent storage device, a network interface, and optionally at least one graphics processing unit. The server runs an operating system such as a server-class operating system and executes an application program implemented using a server-side framework such as a scripting runtime with a web framework or a high-level programming language with a web framework. The server further cooperates with an information storage device implemented by a database management system such as a relational database management system or a non-relational database management system.

A terminal is implemented by a client apparatus such as a smartphone, a tablet, a personal computer, or another general-purpose computing apparatus. The terminal includes a display device, an input device, a network communication interface, and a browser program or a native application. The terminal communicates with the server over a communication network such as a wireless local area network or a cellular network using a protocol such as HTTP over TLS.
A user operates the terminal to access a web page or an application screen provided by the server. The user views target information displayed on the terminal, such as a text passage describing a technical topic or a conceptual explanation. The user inputs answer information in response to a question about the target information using a text input control on the terminal. The terminal converts the user input into character string data encoded in a character encoding format and transmits the character string data to the server together with metadata such as a question identifier and a user identifier.
The server receives the transmitted data through the network interface and passes the data to the application program. The server parses the received data using a data parsing library and stores the answer information as a record in an in-memory data structure, such as an object or a key-value map, and optionally as a row in a database table for logging and later analysis.
The server then prepares data structures for subsequent processing, including a representation of the target information, a representation of the answer information, and associated identifiers.
The server uses a generative AI model implemented as a trained neural network to evaluate a degree of understanding of the user. In one embodiment, the generative AI model is a transformer-based language model comprising an embedding layer, a plurality of self-attention layers, feedforward layers, and an output layer that produces token sequences. The server stores parameters of the generative AI model in a model storage area and loads the parameters into memory when the model is initialized. The server may execute the generative AI model locally on a GPU using a machine learning framework or may access the model through an external inference service using an application programming interface.
The server generates a prompt sentence that instructs the generative AI model to perform a specific computational task. The server constructs the prompt sentence by combining a system instruction segment, a user instruction segment, and a content segment. The system instruction segment defines a role and behavior of the generative AI model. The user instruction segment describes the operation to be executed, such as extracting topics or evaluating understanding. The content segment inserts the actual target information and the answer information.
For example, the server generates a prompt sentence such as:
System: You are an assistant that extracts important related topics and evaluates the user's understanding level.
User: Based on the following user answer and the target information, infer the user's understanding level (low, medium, or high) and extract 3-5 related topics that help deepen understanding.
Target information: “Overview of AI applications in healthcare.”
User answer: “AI is used for medical diagnosis.”
Output: first output the understanding level, then a comma-separated list of topics only.
The server passes the prompt sentence as input to the generative AI model. The server tokenizes the prompt sentence into a sequence of token identifiers using a tokenizer consistent with the model's training configuration, and provides the token sequence to the model's input layer. The model performs a sequence of matrix multiplications, attention weight computations, and nonlinear activations in its transformer layers to produce a probability distribution over output tokens at each decoding step. The server decodes the output token sequence into a text string using a decoding algorithm, such as greedy decoding or sampling with temperature control.
The server analyzes the output text string to derive structured data. In one embodiment, the server parses the understanding level from a prefix in the generated text and splits a subsequent comma-separated list of topics into individual topic strings. The server validates the topics by trimming whitespace, normalizing characters, removing duplicates, and optionally checking each topic against a controlled vocabulary stored in the information storage device. The server then stores the degree of understanding as a discrete value, such as an integer or an enumerated type, in an in-memory structure associated with the user and the target information.
The server uses the extracted topics as query keys to search information resources stored in the information storage device. The server maintains one or more database tables in the relational database management system that store information resources, including fields for a resource identifier, a title, a summary, a uniform resource locator, and one or more classification labels. The server constructs query statements that map each extracted topic onto a normalized topic label and retrieves records whose classification labels match the normalized topic labels. The server may maintain an index structure, such as a B-tree index or an inverted index, on the classification labels to reduce retrieval time and CPU load.
The server additionally generates surrounding information by constructing a second prompt sentence that focuses on topics that are adjacent to, but not identical with, the extracted topics. For example, the server generates a prompt sentence such as:
System: You are an assistant that proposes surrounding topics to broaden user interest.
User: The user answered: “AI is used for medical diagnosis.”
Related topics: image diagnosis, disease prediction, clinical decision support systems.
Please list 3-5 surrounding topics that are not direct applications but can broaden the user's interest (for example, ethics, regulations, or data privacy).
Output: a comma-separated list of topics only.
The server again encodes this prompt sentence and supplies it to the generative AI model.
The model performs inference in the same manner, and the server parses the resulting text into a list of surrounding topics. The server maps these surrounding topics to higher-level classification categories in the database, such as “ethical considerations,” “regulatory frameworks,” or “data management,” and may store these mappings in a separate table or in-memory map to enable optimized retrieval and display.
The server further estimates an emotional state of the user based on the answer information.
In one embodiment, the server generates a prompt sentence that instructs the generative AI model to classify the emotional state using predefined labels such as “confident,” “confused,” or “frustrated.” The prompt sentence may be, for example:
System: You are an assistant that classifies a user's emotional state based on their textual answer.
User: Classify the emotional state of the user as one of the following: confident, neutral, confused, frustrated.
User answer: “I'm not sure if I understand how AI really works in hospitals.”
Output: one label only.
The server parses the output label and encodes the emotional state as a discrete value. In other embodiments, the server uses a separate classifier network or a rule-based heuristic that uses features such as sentiment polarity scores, presence of uncertainty expressions, or intensity markers. The emotional state and the degree of understanding are then used as parameters in a control algorithm that determines a difficulty level and a detail level for subsequent question information and content information.
The server generates new prompt sentences for question generation that incorporate the understanding level, the emotional state, and the extracted topics. For example, the server generates a prompt sentence such as:
System: You are an assistant that generates adaptive questions to help the user learn.
User: The user's understanding level is “medium” and the user appears “confused”.
Related topics: image diagnosis, disease prediction.
Generate one short, clear question that clarifies a core concept in these topics without using technical jargon.
Output: the question sentence only.
The server supplies this prompt sentence to the generative AI model and obtains question information that is tailored to the user's current state. The server may also generate prompt sentences that instruct the model to generate detailed explanations, concise summaries, or step-by-step guides by specifying the desired detail level and vocabulary constraints in the prompt.
The server restructures related information and surrounding information before sending them to the terminal. The server associates each topic and each information resource with classification information stored in the database, such as hierarchical categories or topic clusters. The server computes a grouping of topics into topic groups based on shared classification labels and sorts the groups and topics within each group based on factors such as relevance scores, understanding level, and historical user interactions. The server then constructs presentation information as a hierarchical data structure representing topic groups, topics, and associated resources, which can be serialized and transmitted to the terminal.
The terminal receives the presentation information from the server and renders a user interface that reflects the topic grouping and ordering. The terminal may display topic groups as sections and topics as interactive elements within each section. The terminal enables the user to expand or collapse topic groups, to select specific information resources, and to request additional questions or explanations. The terminal may also adjust visual emphasis based on the difficulty level and detail level determined by the server, such as highlighting recommended items or providing tooltips.
From a technical perspective, the server improves computer technology in several ways. By using structured prompt sentences and intermediate representations (understanding level, emotional state, topic lists, classification mappings), the server reduces redundant invocations of the generative AI model and redundant database queries. The server caches intermediate results and reuses them across multiple interactions, which reduces computational load on the processor and network traffic between the server and the model execution environment. The server's use of topic-based indices and classification information enables faster database retrieval compared to naive keyword search.
Furthermore, the server's orchestration of the generative AI model is not a mere automation of human reasoning; rather, the server implements non-conventional control logic that dynamically alters model behavior through prompt sentences based on internal machine state variables. For example, the server modifies the prompt template and model parameters (such as temperature and maximum output length) according to the understanding level and emotional state, which changes the distribution of generated content in a way that is measurable in terms of completion length, lexical complexity, and semantic coverage. This produces a technical effect of improving the precision and relevance of generated content while reducing the need for repeated user clarification, thereby lowering the total number of network round trips.
The server also improves data management by restructuring information resources according to dynamic topic structures produced by the generative AI model. Instead of static, manually curated taxonomies, the server uses model outputs to adapt the indexing and grouping of resources at run time. This leads to more efficient retrieval paths: the server can prefetch and pre-index only those resources that are reachable through the currently active topic groups, which improves memory locality and reduces disk I/O operations.
The generative AI model used by the server is trained using a supervised or semi-supervised learning procedure. The server or an associated training system prepares training data consisting of input-output pairs where the input includes prompt sentences and the output includes target responses, such as topic lists, explanations, or emotional state labels. The training procedure minimizes a loss function such as cross-entropy between the predicted token distribution and the target token distribution. The training algorithm updates model parameters using gradient-based optimization, such as stochastic gradient descent or Adam, with backpropagation through the transformer layers. Data augmentation techniques, such as paraphrasing and synonym replacement, may be used to increase robustness. The trained model parameters capture statistical regularities of language and domain knowledge, which the server exploits through carefully controlled prompt sentences.
In alternative embodiments, the server employs a multi-model architecture where a first model specializes in understanding-level estimation, a second model specializes in topic extraction, and a third model specializes in question and content generation. The server may also incorporate rule-based components that post-process model outputs, such as filtering out topics that do not exist in the database or enforcing domain-specific constraints. In another variation, the server implements a queue-and-cache mechanism for generative AI requests, where repeated or similar prompt sentences are detected using similarity metrics and answered from a cache to further reduce computation.
The described configurations and variations all contribute to technical improvements in processing speed, retrieval efficiency, and content relevance. Because the server encodes user state, topic structures, and classification mappings into explicit machine-readable data structures and uses them to guide generative AI inference and database access, the system achieves a level of adaptive control and computational optimization that differs from conventional systems relying on static rules or direct, unstructured calls to generative models. As a result, the system provides a concrete improvement to computer-based information processing, particularly in the integrated orchestration of generative AI models, structured data retrieval, and adaptive content presentation across the server and the terminal.

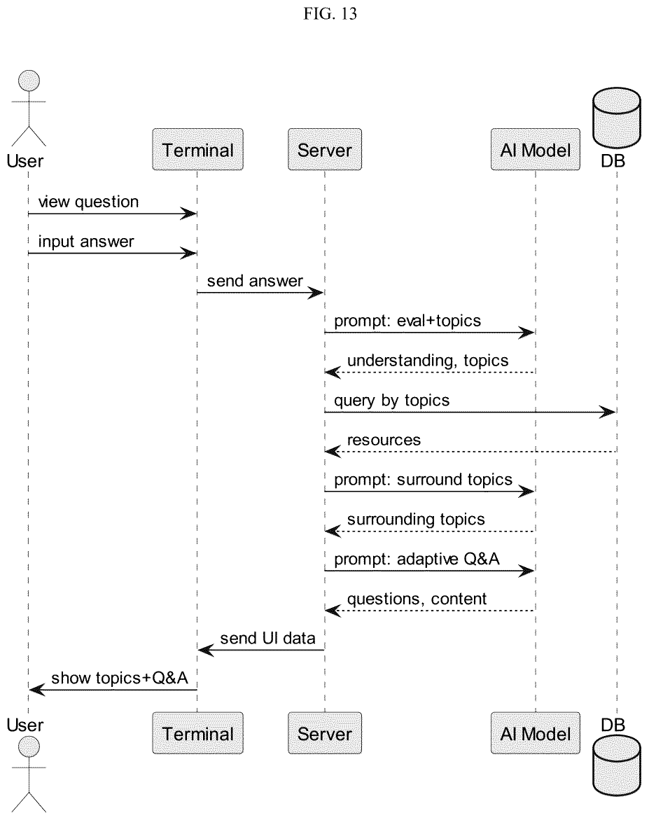

The following describes the processing flow using FIG. 13.

### Step 1:

The user operates the terminal to access an application screen provided by the server.
The terminal displays target information and at least one question about the target information on a display device.
Input: no prior input; the terminal receives screen data from the server (HTML, JSON, or other structured data).
Output: a rendered screen containing the target information and an input field for answer information.
The terminal uses a browser engine or a native UI framework to parse the received screen data, constructs a document object model or equivalent UI structure, and renders text, buttons, and text input controls on the display.

### Step 2:

The user reads the target information on the terminal and inputs answer information into the text input control.
The terminal detects keystrokes or touch input events and accumulates the characters into an internal string buffer encoded in a character encoding format.
Input: human input events such as key presses and touches.
Output: a completed answer string stored in the terminal's memory.
The terminal validates the answer string locally, for example by checking that the length is within a predefined limit and that prohibited characters are not included, and then prepares the answer string for transmission.

### Step 3:

The terminal transmits the answer information and associated metadata to the server.
The terminal constructs a message that includes a question identifier, a user identifier, and the answer string, and serializes the message into a structured format such as JSON.
Input: the validated answer string and metadata.
Output: an encrypted network request sent to the server.
The terminal uses a communication protocol such as HTTPS, applies transport layer security to encrypt the message, and sends the message through a network interface such as a wireless module or wired interface.

### Step 4:

The server receives the network request from the terminal and extracts the answer information.
The server's network interface forwards the request to an application module that deserializes the JSON payload and converts it into internal data structures, such as objects or records.
Input: the encrypted network request from the terminal.
Output: in-memory representations of the user identifier, question identifier, target information identifier, and answer string.
The server performs parsing and basic validation, such as checking for required fields and sanitizing control characters, and stores the parsed data temporarily in a memory area and optionally in a logging table in the information storage device.

### Step 5:

The server generates a first prompt sentence to instruct the generative AI model to evaluate a degree of understanding and to extract related topics.
The server constructs the prompt sentence by concatenating predefined instruction templates with the specific target information and answer string.
Input: the target information text and the user's answer string.
Output: a composed prompt sentence in natural language.
The server uses string processing operations to insert the target information and answer string into designated placeholders and sets control parameters for the generative AI model, such as a requested output format and number of topics.

### Step 6:

The server supplies the first prompt sentence to the generative AI model and performs inference.
The server tokenizes the prompt sentence into a sequence of token identifiers using a tokenizer compatible with the model, and submits the token sequence to the model execution engine.
Input: the prompt sentence as a character string.
Output: a generated text sequence that includes an inferred understanding level and a list of related topics.
The generative AI model, implemented as a neural network, performs matrix multiplications, attention computations, and non-linear activations to calculate probability distributions over output tokens at each position, and the server decodes the most probable tokens or samples from the distributions to form the output text.

### Step 7:

The server parses the generative AI model output to obtain a structured understanding level and topic list.
The server examines the generated text according to the predefined output format, for example by reading a label indicating “low,” “medium,” or “high” understanding, followed by a comma-separated list of topics.
Input: the generated text from the generative AI model.
Output: a discrete understanding level value and an array or list of topic strings.
The server splits the generated text at delimiters, trims whitespace, normalizes character cases, removes duplicate topics, and stores the resulting understanding level and topics in in-memory data structures associated with the user and the current interaction.

### Step 8:

The server searches information resources stored in the information storage device based on the extracted topics.
The server maps each topic string to one or more normalized classification labels and constructs query statements for a database management system.
Input: the list of topic strings.
Output: a collection of information resource records that match the topics.
The server executes the queries using an index on classification labels, retrieves rows that satisfy the selection conditions, and converts each row into a structured record containing fields such as title, summary, and resource identifier.

### Step 9:

The server generates a second prompt sentence to instruct the generative AI model to generate surrounding topics that expand the user's interest.
The server embeds the answer string and the extracted related topics into a prompt template that describes the task of proposing surrounding topics.
Input: the user's answer string and the list of related topics.
Output: a second prompt sentence that requests surrounding topics.
The server arranges the content such that the generative AI model receives clear guidance on which topics are already considered related and which types of new topics are desired, such as ethical or regulatory perspectives.

### Step 10:

The server supplies the second prompt sentence to the generative AI model and obtains surrounding topics.
The server performs tokenization, model inference, and output decoding similarly to Step 6.
Input: the second prompt sentence as a character string.
Output: a text string representing a list of surrounding topics.
The server parses the resulting text into a list of topic strings by splitting at delimiters and normalizing the topics, and stores the list in association with the current interaction state.

### Step 11:

The server estimates an emotional state of the user based on the answer information.
The server either generates a dedicated prompt sentence for emotional classification or applies a classifier model or heuristic rules to the answer string.
Input: the user's answer string.
Output: an emotional state label such as “confident,” “neutral,” “confused,” or “frustrated.”
The server may compute features such as sentiment polarity, presence of uncertainty words, and exclamation or question marks, and map these features to an emotional label, and then store the emotional label as part of the user state representation.

### Step 12:

The server determines a difficulty level and a detail level for subsequent questions and content based on the understanding level and the emotional state.
The server applies a decision algorithm or rule set that maps combinations of understanding level and emotional state to specific levels, for example lowering difficulty when understanding is low and the emotional state is confused.
Input: the understanding level value and the emotional state label.
Output: a difficulty level indicator and a detail level indicator.
The server encodes these indicators as integer levels or enumerated values and stores them in the interaction state to guide later prompt construction and content selection.

### Step 13:

The server generates one or more prompt sentences to instruct the generative AI model to create adaptive questions and content according to the determined levels.
The server incorporates the difficulty level, detail level, understanding level, emotional state, related topics, and surrounding topics into prompt templates.
Input: the user state (understanding level, emotional state) and the topic lists.
Output: prompt sentences for generating follow-up questions and explanatory content.
The server writes explicit constraints in the prompt, such as “avoid technical jargon,” “provide step-by-step explanation,” or “generate one short question,” and passes these prompt sentences to the generative AI model for inference.

### Step 14:

The server obtains generated questions and content from the generative AI model and structures them for presentation.
The server receives generated text sequences that may include one or more questions, explanations, or summaries and parses them according to the requested format.
Input: generated text from the generative AI model in response to the adaptive prompts.
Output: structured question objects and content objects containing fields such as text, type, and priority.
The server may segment the text into multiple units using sentence boundary detection or explicit markers inserted by the model and assign metadata such as which topic each unit relates to.

### Step 15:

The server restructures related information and surrounding information into topic groups with ordering based on classification and user state.
The server associates topics and information resources with classification labels stored in the database and groups them by label to form topic groups.
Input: the lists of related topics, surrounding topics, retrieved information resources, and the user state indicators.
Output: a hierarchical data structure representing topic groups, topics within each group, and associated resources, with a defined display order.
The server calculates relevance scores that combine factors such as topic proximity, understanding level, and previous user interactions, and uses these scores to sort topic groups and resources, and to mark recommended items.

### Step 16:

The server generates presentation information for the terminal by combining the structured questions, content, topic groups, and resources.
The server serializes the hierarchical structure into a response payload that includes fields for each topic group, associated topics, information resource metadata, and generated questions and content text.
Input: structured question objects, content objects, and topic group structure.
Output: a presentation information payload prepared for network transmission.
The server compresses the payload if necessary to reduce data size and attaches headers that identify the response as a content update for the current session.

### Step 17:

The server transmits the presentation information to the terminal.
The server constructs a network response message containing the payload and sends it using a secure protocol.
Input: the presentation information payload.
Output: an encrypted response delivered to the terminal.
The server ensures that the response is associated with the correct user session by including a session identifier and uses connection management mechanisms to handle retransmissions and errors.

### Step 18:

The terminal receives the presentation information and renders an updated user interface.
The terminal decodes and deserializes the payload, reconstructs the topic group hierarchy, questions, and content items, and generates corresponding UI components.
Input: the encrypted response from the server containing the presentation information.
Output: a displayed interface showing grouped topics, related and surrounding information, and adaptive questions and content.
The terminal arranges elements on the screen according to the specified grouping and ordering, and enables interactive operations such as tapping a topic to expand detailed content or selecting a generated question to answer, thereby providing the user with an adaptive learning experience.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning and recommendation systems typically rely on static rule-based logic or fixed decision trees to present questions and content to a user. Such systems generally treat a generative artificial intelligence model, if used at all, as a black-box answer generator that produces questions or explanations in response to a single, coarse prompt. As a result, the systems do not fully exploit the capabilities of the generative model to control and optimize the structure, difficulty, and timing of questions and content in response to fine-grained signals derived from user interaction. Furthermore, in many existing architectures, user answers, behavior logs, and emotional states are stored or analyzed in isolation, without being systematically fed back into the prompt design that governs the operation of the generative model. This leads to several technical problems.

First, the processor that orchestrates question generation and content recommendation often performs only simple retrieval or template substitution, without integrating multi-stage natural language processing, similarity computation, and behavioral analysis into a unified control loop. This results in a limited ability to accurately estimate a user's understanding level and to adjust generative model behavior in real time. The system thereby fails to allocate computation and network resources efficiently, because it cannot prioritize the most relevant prompts, topics, or content candidates according to dynamically computed understanding indices and interest vectors.
Second, known systems generally lack an explicit mechanism to structure and transform heterogeneous data streams-such as text of target information, user answers, emotional signals inferred from device sensors, and interaction logs-into machine-interpretable control inputs for a generative model. Without a well-defined pipeline for constructing prompt sentences from these signals, the processor tends to pass unstructured or overly generic prompts to the generative model, which degrades output relevance, increases output variance, and requires additional post-processing. This increases processor load and latency, and can result in redundant or inappropriate content being transmitted to the user terminal over the network.
Third, most existing systems do not maintain and update a persistent user model-such as an interest vector and preference parameters—that is explicitly used to adjust subsequent prompt sentences and thereby control the generative model across sessions. In the absence of this feedback loop, the system behaves in a myopic manner, repeatedly generating similar questions or content without learning from past selections or viewing times. This not only reduces the personalization quality but also wastes computation by regenerating low-utility content and by failing to converge on content distributions that are more efficient for a particular user or group of users.
Fourth, although some systems attempt to incorporate user emotions, they often treat emotion detection as a separate feature that merely triggers coarse-grained UI changes. Such systems typically do not encode emotional state, understanding level, and topic-specific behavior into structured prompt sentences that direct the generative model to adjust the content, number, and difficulty of questions and content candidates. Consequently, the processor cannot systematically coordinate emotional analysis with natural language generation, and the system is unable to provide a technically robust, dynamically adaptive control path from sensor-derived emotional information to generative model behavior and ultimately to network traffic and user interface state.
Accordingly, there is a need for an improved computer-implemented system and method in which a processor: (i) performs structured acquisition, syntactic analysis, and summarization of target information; (ii) computes understanding indices by similarity computation between normalized user answers and reference concepts; (iii) constructs prompt sentences that explicitly encode understanding levels, emotional states, and user interest vectors; and (iv) uses these prompt sentences to control a generative artificial intelligence model in an iterative feedback loop. Such an architecture should reduce unnecessary computation and network usage, improve the relevance and stability of generated questions and content, and enhance the efficiency of the overall information processing pipeline by tightly integrating analytics outputs into the generative model control mechanism.

The specific processing by the specific processing unit 290 of the data processing device 12 in Application Example 2 is realized by the following means.

The present invention provides a server comprising a processor configured to (i) acquire identification information and meta-information of target information from a user terminal, acquire character information related to the target information based on the identification information and the meta-information, perform syntactic analysis and summarization processing on the character information, and extract a summary and main concepts of the target information; (ii) generate, based on the summary, the main concepts, user attribute information, and learning history information, a prompt sentence for instructing a generative artificial intelligence model to generate a plurality of questions for measuring a degree of understanding of a user, obtain the plurality of questions from the generative artificial intelligence model, convert the obtained questions into structured data, and transmit the structured data to the user terminal; (iii) obtain answer data of the user to the plurality of questions from the user terminal, normalize the answer data by using natural language processing, calculate, by similarity computation between the normalized answer data and reference concepts extracted from the target information, an understanding index for each question, and evaluate an understanding level of the user with respect to the target information based on the understanding indexes; (iv) generate, based on the answer data and the understanding level, a prompt sentence for instructing the generative artificial intelligence model to output candidate topics for related information and peripheral information, obtain the candidate topics from the generative artificial intelligence model, search for information resources corresponding to the candidate topics, rank the information resources based on difficulty, relevance, and novelty, and structure the ranked information resources as recommendation information; (v) estimate an emotional state of the user based on at least one of facial information, voice information, and operation history information obtained from the user terminal, generate, according to the emotional state and the understanding level, a prompt sentence for instructing the generative artificial intelligence model to dynamically adjust content, number, and difficulty of questions or contents, and output questions or contents regenerated according to the generated prompt sentence as data for presentation to the user terminal; and (vi) obtain, from the user terminal, user selection information regarding the recommendation information and behavioral log information including viewing time or browsing time, update an interest vector and preference parameters of the user based on the behavioral log information, and adjust contents of a subsequently generated prompt sentence by using the updated interest vector and preference parameters so as to sequentially increase a degree of individualization of question generation and content recommendation. This enables the server to implement a closed-loop control architecture in which analytical outputs derived from text processing, similarity computation, emotional state estimation, and behavioral logging are systematically encoded into prompt sentences that govern the operation of the generative artificial intelligence model, thereby improving the technical efficiency, responsiveness, and personalization quality of computer-based question generation and content recommendation while reducing redundant computation and network transmission in the information processing system.

The term “system” refers to a combination of one or more hardware devices and software modules that cooperate to execute the processing described in the claims, including at least a processor and one or more user terminals connected via a communication network.

The term “processor” refers to a hardware execution unit, such as a central processing unit or other arithmetic and logic circuit, configured to execute instructions of a program to perform the information processing steps described in the claims.
The term “user terminal” refers to an information processing device operated by a user, such as a portable communication device, a wearable device, a personal computer, or another client device, that communicates with the server and presents questions or content to the user.
The term “target information” refers to information that is an object of user learning or interest, such as a topic, a content item, or a document, including but not limited to text, audio, video, or multimedia materials.
The term “identification information” refers to information used to uniquely or quasi-uniquely identify the target information within a storage system, such as an identifier, an index value, or address information.
The term “meta-information” refers to auxiliary information associated with the target information, such as a title, a category, a tag, a time stamp, or other descriptive attribute data.
The term “character information” refers to textual data derived from the target information, including a transcript, subtitles, extracted text, or any other sequence of characters suitable for natural language processing.
The term “syntactic analysis” refers to processing for analyzing a grammatical or structural relationship within the character information, including segmentation into sentences, tokenization into words, and extraction of syntactic or dependency structures.
The term “summarization processing” refers to processing for generating a reduced-length representation of the character information that preserves main points, including extractive or abstractive summarization.
The term “summary” refers to a shortened representation of the target information obtained by summarization processing and expressing main content or key ideas.
The term “main concepts” refers to important terms, entities, or topics extracted from the target information and used to characterize its semantic content.
The term “user attribute information” refers to information indicating user characteristics, such as age group, language preference, skill level, or other profile attributes.
The term “learning history information” refers to information indicating past learning-related behavior of the user, such as previously viewed contents, answered questions, scores, or completed topics.
The term “generative artificial intelligence model” refers to a machine learning model configured to generate natural language or other data in response to an input, such as a neural network based language model used to output questions, topics, or content candidates.
The term “prompt sentence” refers to an input text or structured instruction supplied to the generative artificial intelligence model in order to specify a generation task, a style, constraints, or conditions for the model output.
The term “question” refers to an interrogative expression or prompt presented to the user for the purpose of obtaining an answer and thereby measuring or stimulating understanding.
The term “structured data” refers to data formatted according to a predetermined structure, such as records with fields or objects with attributes, enabling deterministic parsing and processing by a program.
The term “answer data” refers to data representing responses provided by the user to questions, including free-text responses, selected choices, or other forms of input.
The term “natural language processing” refers to computational processing techniques that operate on human language text, including tokenization, normalization, morphological analysis, semantic similarity computation, and related operations.
The term “reference concepts” refers to concepts or key terms extracted from the target information and used as a basis for comparison or evaluation of user answers.
The term “similarity computation” refers to processing that quantifies similarity between two pieces of information, such as between a normalized user answer and a reference concept, using distance measures, vector similarity, or other mathematical methods.
The term “understanding index” refers to a numerical or categorical indicator computed for each question that represents how well the user's answer matches the reference concepts.
The term “understanding level” refers to an aggregated indicator representing the user's degree of understanding of the target information, derived from one or more understanding indexes.
The term “candidate topic” refers to a subject, keyword, or heading proposed by the generative artificial intelligence model as a possible related topic or peripheral topic for additional information provision.
The term “related information” refers to information that is thematically associated with the target information and serves to deepen the user's understanding of the same general subject.
The term “peripheral information” refers to information that is not the core of the target information but is contextually or conceptually adjacent and helps to broaden the user's understanding.
The term “information resource” refers to a stored unit of information, such as a document, a record, a multimedia file, or an external content item accessible through a communication network.
The term “recommendation information” refers to data defining a set of information resources proposed to the user, including rankings, descriptions, and control parameters for presentation.
The term “facial information” refers to sensor data or processed data representing the appearance, movement, or expression of a user's face, acquired for example by an imaging device.
The term “voice information” refers to audio data or processed data representing speech or vocal characteristics of the user, acquired for example by a microphone.
The term “operation history information” refers to data representing a sequence of user interactions with the user terminal, such as key inputs, touch operations, scrolling, selection events, or timing of such operations.
The term “emotional state” refers to an inferred psychological condition of the user, such as happiness, interest, boredom, or excitement, estimated from facial information, voice information, or operation history information.
The term “content” refers to information items presented to the user, including questions, explanations, documents, audiovisual materials, or other media elements.
The term “behavioral log information” refers to recorded data describing the user's interaction behavior with presented contents or recommendations, including at least viewing time, browsing time, and selection events.
The term “interest vector” refers to a structured representation, such as a numerical vector, that encodes one or more aspects of the user's interests in topics, content types, or attributes.
The term “preference parameters” refers to parameter values representing user preferences with respect to attributes of contents, such as media type, difficulty, length, or style.
The term “degree of individualization” refers to a measure of how specifically the generated questions or recommended contents are adapted to characteristics, understanding level, and preferences of the individual user.
The term “user selection information” refers to data indicating which information resources, questions, or content items the user has chosen, opened, accepted, or rejected.
The term “additional introductory question” refers to a question generated to address basic or foundational aspects of a topic for a user whose understanding level is relatively low in that topic.
The term “advanced question” refers to a question generated to address deeper or more complex aspects of a topic for a user whose understanding level is relatively high in that topic.
The term “error tendency” refers to a pattern of incorrect answers or misconceptions repeatedly exhibited by the user, as detected from answer data.
The term “unlearned concept” refers to a concept that is relevant to the target information but has not yet been correctly answered or sufficiently addressed by the user.
The term “preferred media type” refers to a category of content format favored by the user, such as short video, long-form text, audio program, or interactive quiz.
The term “learning information resource” refers to an information resource whose primary purpose is to support education, explanation, or structured learning of a topic.
The term “entertainment information resource” refers to an information resource whose primary purpose is to provide enjoyment, diversion, or narrative content while potentially also relating to the topic.
The term “content candidate” refers to a potential item of content, such as a learning information resource or an entertainment information resource, proposed by the generative artificial intelligence model before final selection by the system.
The term “educational content group” refers to a subset of content candidates selected for presentation to the user that primarily consists of learning information resources.
The term “entertainment content group” refers to a subset of content candidates selected for presentation to the user that primarily consists of entertainment information resources.
The term “presentation control information” refers to data specifying how, where, and in what manner contents are to be displayed or provided at the user terminal, including layout, grouping, and visual or auditory distinctions between content groups.

In one embodiment, a server cooperates with at least one user terminal over a communication network to implement the claimed system. The server includes a processor, a main memory, a non-volatile storage device, a network interface, and optionally a graphics processing unit. The user terminal includes a processor, a display unit, an input unit such as a touch panel or keyboard, an audio input unit such as a microphone, an imaging unit such as a camera, a main memory, a non-volatile storage device, and a wireless or wired communication interface.

The server executes an operating system such as a general-purpose server operating system and executes application software implemented, for example, in a programming language such as Python. The server stores in the storage device program modules including a text preprocessing module, a user modeling module, an emotional state estimation module, a prompt generation module, a generative AI calling module, a ranking module, and a logging and analytics module. The server also stores trained machine learning models, such as a natural language encoder, a semantic similarity model, an emotional classification model, and a generative AI model or a client module for accessing an external generative AI service.
The server uses a natural language processing library, such as a sentence segmentation and tokenization library, a syntactic parser, and a named entity recognizer, to perform syntactic analysis and summarization of character information. The server may use a data analysis library such as a tabular data processing library to manage user history and log data, and a machine learning library such as a vectorization library or a model training library to compute similarity scores, update interest vectors, and train auxiliary models. The generative AI model may be implemented as a large-scale neural language model deployed on the server or accessed as a remote service through an application programming interface.
The terminal executes an operating system such as a mobile device operating system and an application program that communicates with the server through the network interface. The terminal uses a user interface framework such as a widget framework or a view-based framework to display questions, recommendation lists, and other content to the user. The terminal uses the camera and microphone to acquire facial information and voice information of the user and uses the input unit to capture operation history information. The terminal sends these data as structured messages to the server through a secure communication channel.
The server acquires identification information and meta-information of target information from the terminal. The target information may be a video, an article, or another content item that the user is currently viewing or has selected. The server reads character information such as a transcript or extracted text associated with the target information from a content database stored in the storage device. The server then performs syntactic analysis by segmenting the character information into sentences, tokenizing the sentences into tokens, and constructing a syntactic structure such as a dependency tree. The server further executes summarization processing by either selecting important sentences based on scoring of tokens and entities or by using an encoder-decoder neural network trained for abstractive summarization. The server thereby obtains a summary and a set of main concepts as feature vectors or term lists.
The server stores the summary and main concepts in a data structure such as a relational table or a document store, associated with the target information identifier. The server also loads user attribute information and learning history information from a user profile store. The learning history information may include past contents, past question-answer pairs, previous understanding levels, and interaction statistics such as completion rates and time spent. The server concatenates the summary, the main concepts, the user attribute information, and the learning history information into a feature representation used for prompt design.
The server generates a prompt sentence for a generative AI model by inserting the previously generated summary and main concepts into a textual template stored in the prompt generation module. In one example, the server generates a prompt sentence such as:
“Generate five short comprehension questions to measure a non-expert user's understanding of the following topic. Focus on key concepts and causes. Topic summary: [summary text].
Key terms: [term list].”
The server passes the prompt sentence to the generative AI calling module. The generative AI calling module converts the prompt sentence into token identifiers using a tokenizer associated with the generative AI model and sends the token sequence to the generative AI model together with generation parameters such as a temperature value, a maximum output length, and a top-k or nucleus sampling parameter. The generative AI model is, for example, a transformer-based decoder-only neural network with multiple attention layers, trained on large-scale text data using a next-token prediction objective. The generative AI model outputs a sequence of tokens representing candidate questions. The server decodes the tokens back into text, splits the text into individual questions based on delimiter detection, and removes formatting artifacts.
The server converts each question into a structured representation containing fields such as a question identifier, question text, target concept identifiers, and a preliminary difficulty estimate obtained, for example, by heuristic rules based on token length and linguistic complexity. The server transmits the structured representation to the terminal via the network interface in a format such as a structured text format.
The terminal receives the questions and renders them on the display unit. The terminal may overlay the questions on the currently presented target information, such as displaying a floating panel above a video player. The terminal provides input components for each question, such as text input fields or multiple-choice buttons. The user reads each question and enters an answer using the input unit. If the terminal supports voice input, the terminal converts the voice signal into text by using a speech recognition module executed locally or on another server. The terminal records the answer text, timestamps, and interaction events such as scrolling or editing actions and transmits this answer data to the server.
The server receives the answer data and stores it in the storage device. The server then normalizes the answer text by converting it to lowercase, removing punctuation, and applying morphological normalization such as lemmatization. The server represents both the normalized answer and the reference concepts from the target information as vectors using a sentence embedding model such as a transformer-based encoder trained for semantic similarity. The server computes similarity scores such as cosine similarity between the answer vector and each reference concept vector and combines these scores into an understanding index for each question. For example, the server may compute a weighted average of similarity scores, where weights are derived from concept importance values learned from earlier user populations.
The server aggregates the understanding indexes over all questions to compute an understanding level for the user for the target information. The server may classify the understanding level into discrete categories such as “low,” “medium,” or “high” based on thresholds determined during a configuration process. The server stores the understanding level in the user profile.
The server generates another prompt sentence based on the answer data and the understanding level to instruct the generative AI model to output related information and peripheral information. In one example, the server generates a prompt sentence such as:
“Based on the user's answer and comprehension level, suggest 3-5 related topics that will deepen and broaden understanding. User answer: ‘increase in greenhouse gases’. Content theme: climate change. User level: basic. Output clear topic titles and one-sentence explanations for each.”
The server passes this prompt sentence through the generative AI calling module. The generative AI model outputs a text describing candidate topics. The server parses this text, for example by detecting line breaks or bullet markers, and extracts titles and short descriptions.
The server then maps candidate topics to information resources in a content database by using a search index. The server computes ranking scores for the information resources by combining features such as textual similarity to the topic description, estimated difficulty level, novelty relative to previously presented contents, and alignment with user preferences stored as an interest vector and preference parameters.
The server constructs recommendation information as a structured list of information resources with fields such as title, description, difficulty label, novelty score, and content type. The server transmits this recommendation information to the terminal. The terminal displays the recommendation information on the display unit, for example in a scrollable list of cards that the user can select. Some cards may correspond to educational content, while other cards correspond to entertainment content such as audiovisual works related to the same or a peripheral topic.
The terminal acquires facial information and voice information of the user by capturing images and audio during interactions, subject to privacy controls. The terminal also records operation history information such as the sequence of taps and the duration of pauses. The terminal transmits these data to the server as sensor data and interaction logs.
The server processes the sensor data with the emotional state estimation module. The server, for example, extracts facial features from images by using a convolutional neural network trained for facial expression recognition and extracts acoustic features from voice data by computing spectrograms and applying a recurrent neural network or transformer-based classifier. The server combines these features and operation history features in a multi-modal classifier to estimate an emotional state such as interest, boredom, confusion, or excitement.
The server stores the estimated emotional state in association with the corresponding content and time.
The server generates further prompt sentences that encode both the understanding level and the current emotional state. In one example, the server generates a prompt sentence such as:
“Generate three follow-up questions that are slightly more challenging than the previous ones but remain suitable for a user at a basic level and currently showing high interest. Theme: climate change and greenhouse gases.”
In another example, the server generates a prompt sentence such as:
“Generate two easier, motivating questions focusing on concrete everyday examples for a user who shows signs of boredom and low understanding on the topic ‘climate change’.”
The generative AI model generates adjusted questions in response to these prompt sentences.
The server forwards the adjusted questions to the terminal, which presents them to the user.
This adjustment process differs from merely repeating the same questions or from rule-based branching, because the prompt sentences precisely encode continuous variables such as similarity-based understanding indexes, emotional probability distributions, and interest vectors, and the generative AI model maps these conditions to linguistic modifications of difficulty, phrasing, and topic coverage.
The server logs user selections from recommendation information and behavioral log information such as which content items were opened and for how long they were viewed.
The user modeling module updates a user-specific interest vector by applying an online learning algorithm, such as a matrix factorization update or a neural embedding update, which shifts vector weights toward topics and content types that the user actually consumes.
The server also updates preference parameters for attributes such as media type and typical length.
The server uses the updated interest vector and preference parameters when generating subsequent prompt sentences. For instance, the server may generate a prompt sentence such as:
“Considering that the user frequently chooses short videos and documentaries about climate change, generate three concise video-friendly topic suggestions to keep the user engaged. Current interest: greenhouse gases and international agreements.”
By doing so, the server shapes the behavior of the generative AI model in a way that aligns with the user's long-term interaction patterns, thereby reducing the likelihood of selecting content that the user is unlikely to engage with. This reduction in unsuitable generations saves computation both on the generative model side and on the server ranking side and reduces the amount of data transmitted to the terminal.
The server thereby implements a closed-loop control of the generative AI model based on multi-modal data: target content analysis, answer similarity, emotional state inference, and behavioral logs. The system improves computer technology in several ways. First, the system reduces processing time and network load by constructing precise prompt sentences that cause the generative AI model to output focused results, thereby reducing the need for extensive downstream filtering or multiple trial generations. Second, the system improves accuracy of understanding estimation and content recommendation by combining neural semantic similarity, structured logging, and feedback-based user model updates in a manner that could not be performed by manual human operation at comparable scale or speed. Third, the system improves data management by maintaining a coherent data structure linking target information, questions, answers, understanding indexes, emotional states, recommended resources, and prompt histories, enabling consistent reuse and audit of model decisions.
The server uses specific algorithms and model structures, rather than abstract “AI decisions.”
For example, the generative AI model uses a transformer architecture with a defined number of layers, attention heads, and hidden dimensions, trained on a tokenized corpus with a cross-entropy loss function and weight updates by a gradient-based optimizer. The semantic similarity model may use a dual-encoder architecture that maps sentences into a shared embedding space, enabling efficient similarity computation by vector inner products. The emotional classification model applies convolution layers and recurrent layers to frame-level features, and updates its weights using a classification loss based on labeled emotional data.
The user modeling algorithm may use a stochastic gradient update rule to adjust the interest vector and preference parameters after each interaction.
The server defines non-conventional data structures, such as an understanding index table, an emotional state timeline, and a prompt history log that link across different processing modules. The prompt history log records not only the textual prompt sentences but also the associated feature vectors (summary embeddings, interest vectors, emotional state probabilities), generation parameters, and response statistics. This structure enables the server to analytically refine prompt strategies and avoid repeated suboptimal prompts, which yields a technical improvement in how computation time and generative AI calls are allocated.
The system is not limited to a single configuration. In a variation, the generative AI model is executed locally on the server's GPU in an optimized inference engine, while in another variation, the server calls an external generative AI service. In a further embodiment, the semantic similarity model and emotional classification model may be jointly trained to share an encoder backbone, reducing memory usage and inference time. In another embodiment, the terminal may perform a portion of emotional state estimation locally using a lightweight model and send only the estimated emotional states to the server, further reducing network usage.
The server can also adapt to different application domains by adjusting the content database, the configuration of understanding level thresholds, and the template sets for prompt sentences. However, the core technical concept remains: the server constructs and updates prompt sentences that encode internal analytic states of the system-understanding indexes, emotional states, interest vectors—in a structured manner and uses those prompt sentences to control a generative AI model, thereby improving the efficiency, performance, and personalization of question generation and content recommendation in a way that is specifically tailored to computer-based processing and would not be achievable by human operators acting without such data structures and algorithms.

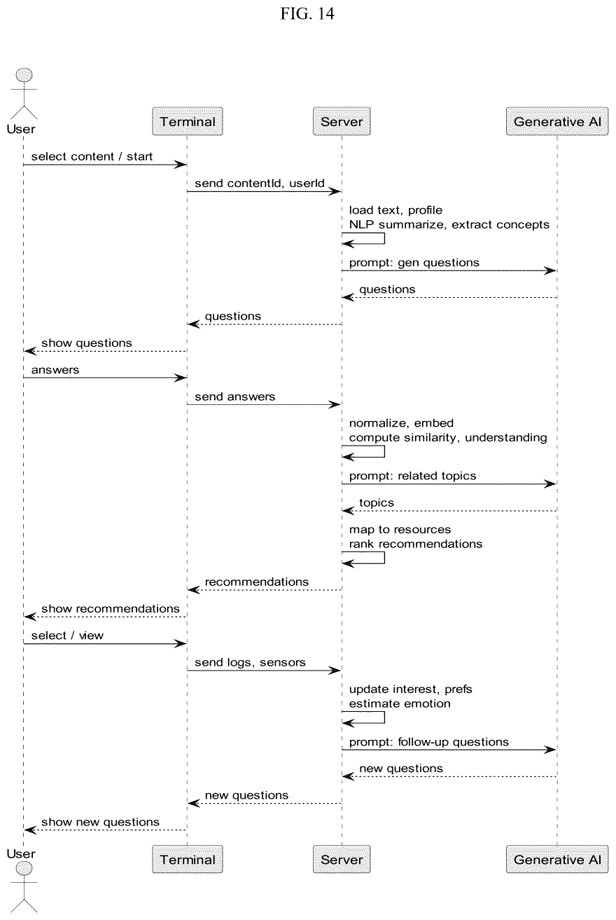

The following describes the processing flow using FIG. 14.

### Step 1:

Server acquires target information metadata and text.
Server receives, as input, from the terminal: a target content identifier, meta-information (such as title, category, tags, and language), and optionally a flag indicating whether a transcript is required. Based on this input, server queries a content database and retrieves, as intermediate data, a transcript or textual description associated with the target content. Server performs data processing by decoding text from storage format, validating character encoding, and removing markup tags. Server outputs cleaned character information and a record linking the target content identifier to the retrieved text into a temporary data structure in memory.

### Step 2:

Server performs syntactic analysis and summarization of target text.
Server takes, as input, the cleaned character information from Step 1. Server executes natural language processing that segments the text into sentences, tokenizes sentences into tokens, and performs part-of-speech tagging and dependency parsing using a syntactic analysis library. Server computes sentence scores based on token frequency, position, and presence of key parts of speech; or applies an encoder-decoder summarization model to the full text.
Server performs data computation by ranking or decoding sentences to construct a condensed representation. Server outputs a summary string and a list of main concepts (such as key terms and entities) stored in a structured format with fields including concept identifier, surface form, and importance score.

### Step 3:

Server loads user profile and learning history.
Server receives, as input, a user identifier from the terminal along with a session token.
Server queries a user profile store using the user identifier and obtains user attribute information (such as proficiency level and preferred language) and learning history information (such as past contents, past questions, and understanding levels). Server performs data processing by aggregating these records, removing obsolete entries, and encoding attributes (for example, mapping proficiency to categorical flags). Server outputs a user profile object containing attributes, summarized learning history, and initial interest vector values used for further computation.

### Step 4:

Server constructs a prompt sentence for initial question generation.
Server uses, as input, the summary, main concepts, user attribute information, and learning history object from Steps 2 and 3. Server assembles these data into a textual template by string concatenation and placeholder replacement. For example, server generates a prompt sentence of the form:
“Generate five short comprehension questions to measure a non-expert user's understanding of the following topic. Focus on key concepts and causes. Topic summary: [summary text].
Key terms: [term list].”
Server performs data processing by limiting the summary length, sorting main concepts by importance, and formatting them as a comma-separated list. Server outputs a completed prompt sentence as a UTF-8 string ready to be supplied to the generative AI model.

### Step 5:

Server invokes the generative AI model to generate questions.
Server takes, as input, the prompt sentence from Step 4 and generation parameters such as maximum token count, sampling temperature, and top-k or top-p settings. Server passes the prompt sentence to a tokenizer associated with the generative AI model, converting the text into a sequence of token identifiers. Server sends these token identifiers and parameters over an internal interface or external API to the generative AI model. The generative AI model performs numerical computation within a transformer-based architecture, executing matrix multiplications and attention operations layer by layer to predict next tokens. Server receives, as output, a sequence of generated token identifiers from the model, decodes them into text, and performs post-processing such as splitting at delimiters into individual question strings and trimming extraneous characters. Server outputs a list of question texts.

### Step 6:

Server structures generated questions and sends them to the terminal.
Server takes, as input, the list of question texts from Step 5. Server assigns each question a unique question identifier, associates each with the target content identifier and estimated difficulty (for example, based on length and vocabulary complexity), and packages them into a structured data format. Server performs data processing by creating objects with fields such as question_id, content_id, text, and type (for example, free-text answer type). Server sends this structured question list as an API response to the terminal. Server outputs a network message containing the question list and logs the transaction for analytics.

### Step 7:

Terminal renders questions and presents them to the user.
Terminal receives, as input, the structured question list from the server. Terminal parses the structured data into in-memory objects and maps question fields to corresponding user interface elements. Terminal performs data processing by generating view components for each question, such as text labels and text input boxes, and associates event handlers with “submit” buttons. Terminal displays the questions on the display unit, for example as an overlay panel on top of a content viewer. Terminal outputs a user interface state in which the user can visually read each question and interact with answer input controls.

### Step 8:

User reads questions and inputs answers.
User observes, as input, the question text presented on the terminal display. User performs physical actions such as touching the screen, pressing keys, or speaking into the microphone to provide an answer. User may edit the answer text before submission. User triggers a submission event by tapping a button or pressing a key. User outputs answer information including textual responses and implicit timing information (such as the time interval between question display and submission) that is captured by the terminal.

### Step 9:

Terminal collects answer data and transmits it to the server.
Terminal receives, as input, user-entered answers from the input unit and associated interaction timestamps. Terminal aggregates answers into a data structure containing user identifier, content identifier, question identifiers, answer texts, and answer times. Terminal may perform lightweight preprocessing such as trimming whitespace and encoding text as UTF-8. Terminal performs data processing by packaging data into a structured format suitable for network transmission and optionally encrypts the payload. Terminal sends the answer data to the server over a secure communication channel and outputs a network request containing the collected answers.

### Step 10:

Server normalizes answers and computes understanding indexes.
Server receives, as input, the answer data from the terminal. Server extracts answer texts and corresponding question identifiers and retrieves the reference concepts for the target content stored in Step 2. Server applies natural language processing to each answer, including lowercasing, punctuation removal, and lemmatization using a linguistic library. Server encodes normalized answers and reference concepts into vector representations using a semantic embedding model. Server performs data computation by calculating similarity measures, such as cosine similarity, between each answer vector and the corresponding reference concept vectors. Server combines similarity values using weighted averaging or other aggregation methods to compute an understanding index for each question. Server outputs understanding indexes per question and updates a cumulative understanding level for the content and user.

### Step 11:

Server evaluates the overall understanding level.
Server uses, as input, the per-question understanding indexes from Step 10. Server applies a classification or thresholding algorithm, such as comparing the mean or median understanding index to preconfigured boundaries, to categorize the user's understanding level into levels like “low,” “medium,” or “high.” Server may also produce a continuous understanding score. Server stores this understanding level in a user profile record associated with the content identifier and timestamp. Server outputs an understanding level indicator and may generate diagnostic flags, such as “key concept not mastered,” for later use.

### Step 12:

Server constructs a prompt sentence for related topic generation.
Server takes, as input, the user's original answer data, the understanding level from Step 11, and the main concepts list from Step 2. Server selects a subset of concepts corresponding to incorrectly or weakly understood areas based on understanding indexes. Server embeds the selected answer phrases, content theme, and understanding level into a prompt template. For example, server generates:
“Based on the user's answer and comprehension level, suggest 3-5 related topics that will deepen and broaden understanding. User answer: ‘increase in greenhouse gases’. Content theme: climate change. User level: basic. Output clear topic titles and one-sentence explanations for each.”
Server performs data processing by truncating user answers to a safe length, encoding the understanding level into descriptive text, and concatenating fields with delimiters. Server outputs a new prompt sentence ready to be passed to the generative AI model.

### Step 13:

Server calls the generative AI model to propose candidate topics.
Server receives, as input, the related-topic prompt sentence from Step 12 and generation parameters. Server tokenizes the prompt sentence and invokes the generative AI model, which performs internal numerical operations across multiple transformer layers. Server obtains, as output, a generated text listing candidate topics and associated explanations.
Server applies parsing logic to detect line breaks or list markers and splits the output into discrete candidate topics. Server outputs a structured candidate topics list with fields such as title and description for each candidate.

### Step 14:

Server maps candidate topics to information resources and ranks them.
Server takes, as input, the candidate topics list from Step 13. Server queries a content index or search engine using the topic titles and descriptions as query terms. Server retrieves, as intermediate data, a set of information resources for each candidate topic. Server computes ranking scores by combining features such as textual similarity between resource metadata and the topic description, difficulty level compared to the user's understanding level, novelty relative to historical consumption, and alignment with the user's interest vector. Server may use a ranking model or a weighted sum formula. Server outputs a recommendation information list where each entry contains an information resource identifier, title, description, rank score, and labels such as “educational” or “entertainment.”

### Step 15:

Server sends recommendation information to the terminal.
Server uses, as input, the ranked recommendation list from Step 14. Server packages the list into a structured response message, including fields for display such as titles and descriptions, as well as control fields such as content type and recommended group assignment. Server transmits this message to the terminal over the network interface and logs the operation in an analytics store. Server outputs a network response containing all recommendation information tailored to the user.

### Step 16:

Terminal displays educational and entertainment recommendations.
Terminal receives, as input, the recommendation information from the server. Terminal parses the structure and categorizes items into groups, for example an educational content group and an entertainment content group based on content type labels. Terminal creates user interface components such as separate sections or tabs to display each group distinctly.
Terminal performs data processing by binding resource metadata to visual elements such as thumbnails, titles, and short text descriptions. Terminal outputs a user interface state where the user can browse and select recommended items, with educational and entertainment content visually distinguished.

### Step 17:

User selects recommendations and consumes content.
User views, as input, the displayed recommendation lists on the terminal. User scrolls through items, taps on one or more resource entries, and confirms playback or opening if necessary. User then watches, reads, or listens to the selected content. User may provide explicit feedback such as tapping a “like” or “not interested” button. User's actions generate selection events and viewing durations captured by the terminal, which form the user's output in this step.

### Step 18:

Terminal logs user behavior and sends feedback to the server.
Terminal receives, as input, user interaction events including which items are selected, how long they are viewed, and any feedback actions. Terminal aggregates these events into behavioral log records that include user identifier, resource identifier, timestamps, and event types. Terminal performs data processing by compressing and batching records to optimize transmission. Terminal sends the behavior logs and feedback data to the server as an asynchronous report. Terminal outputs one or more batched log messages over the network.

### Step 19:

Server updates interest vector and preference parameters.
Server receives, as input, behavioral log records from the terminal. Server identifies patterns such as frequent selection of certain topics, content lengths, and media types. Server executes an update algorithm that adjusts the user's interest vector and preference parameters, for example by applying gradient-based updates toward features of consumed resources and away from features of quickly abandoned resources. Server performs data computation by normalizing updated vectors and storing them in the user profile store. Server outputs an updated user model that reflects current interests and preferences.

### Step 20:

Server performs emotional state estimation based on sensor and interaction data.
Server takes, as input, facial images, voice recordings, and operation history information transmitted from the terminal. Server preprocesses image data by resizing and normalizing pixel values, and preprocesses audio data by computing spectrograms or other acoustic feature representations. Server feeds these data into an emotional classification model that outputs probability scores for different emotional states. Server also converts operation history into numerical features such as typing speed, pause length, and scroll frequency.
Server may combine probabilistic emotional outputs with behavioral features through a fusion network. Server outputs an estimated emotional state label and confidence values, which are recorded alongside the user's understanding level.

### Step 21:

Server creates adjusted prompt sentences for follow-up question generation.
Server uses, as input, the updated understanding level from Step 11, the emotional state from Step 20, and the user model from Step 19. Server determines, via conditional rules or a small control model, whether to increase, decrease, or maintain question difficulty and quantity.
Server then generates a prompt sentence such as:
“Generate three follow-up questions that are slightly more challenging than the previous ones but remain suitable for a user at a basic level and currently showing high interest. Theme: climate change and greenhouse gases.”
or
“Generate two easier, motivating questions focusing on concrete everyday examples for a user who shows signs of boredom and low understanding on the topic ‘climate change’.”
Server performs data processing by embedding numeric understanding scores and emotional probabilities into descriptive text fields, ensuring the generative AI model receives an explicit specification of desired difficulty and tone. Server outputs one or more adjusted prompt sentences for subsequent generative AI calls.

### Step 22:

Server generates and delivers adjusted follow-up questions.
Server receives, as input, the adjusted prompt sentences from Step 21. Server invokes the generative AI model again, performing tokenization, forward-pass computation, and text decoding similar to previous calls. Server parses the generated text into discrete questions and may apply filtering rules to avoid repetition with prior questions based on text similarity checks. Server constructs structured question objects with updated difficulty tags and identifiers. Server sends these new question objects to the terminal. Server outputs a network response that extends the interactive session with tailored follow-up questions.

### Step 23:

Terminal presents adjusted questions; user continues interaction.
Terminal receives, as input, the adjusted questions from the server. Terminal updates the user interface by appending or replacing question views with the new set. Terminal may visually indicate that these are follow-up questions to encourage continued engagement. User observes these questions, provides new answers, and the interaction cycle from Steps 8 through 10 may repeat. Terminal outputs new answer data and interaction events, which feed back into the system's closed-loop control.

### Step 24:

Server maintains a prompt history and refines future control.
Server receives, as input, logs of all prompt sentences used, generative AI outputs, user responses, understanding indexes, emotional states, and behavioral logs. Server stores these in a prompt history structure that links prompt content with subsequent user and model outcomes. Server periodically analyzes this history using statistical or machine learning techniques to identify which prompt patterns yield improved understanding and engagement with minimal computational cost. Server updates internal rules and parameters for the prompt generation module, such as preferring certain templates or restricting ineffective parameter combinations. Server outputs optimized configuration values and updated template sets, which improve subsequent prompt design and overall system performance.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.
The data generation model 58 is obtained by performing deep learning with a neural network.
The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

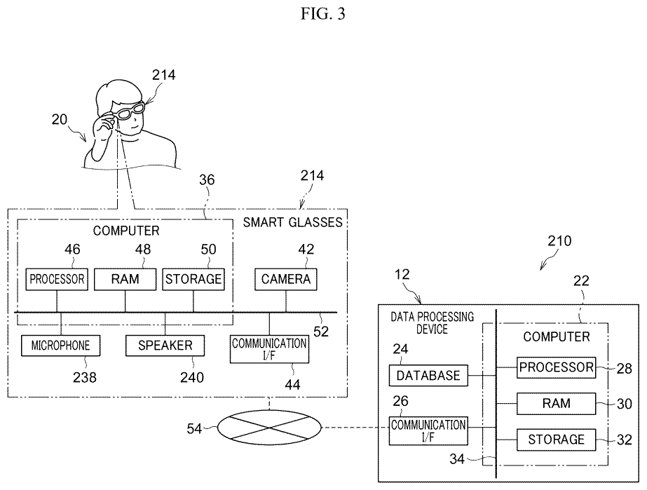

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

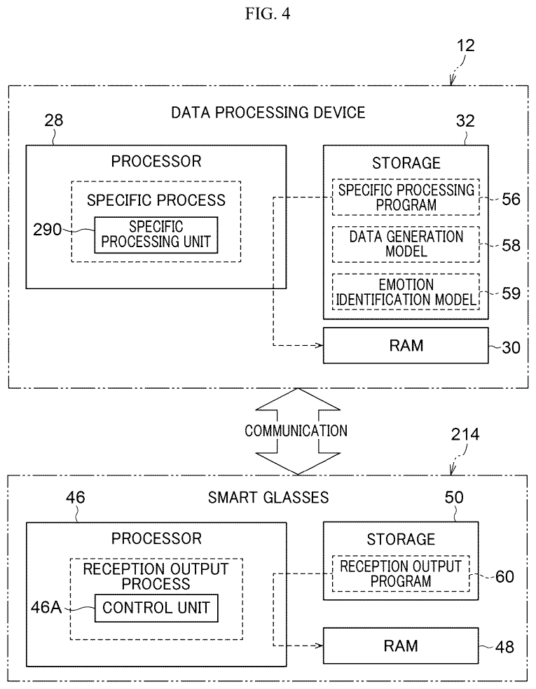

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

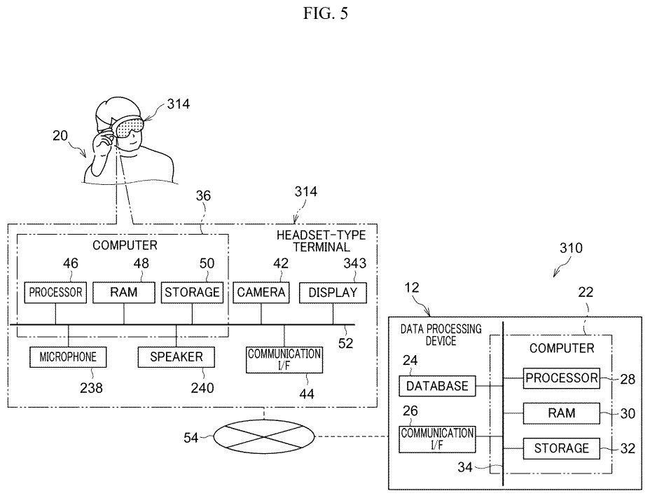

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

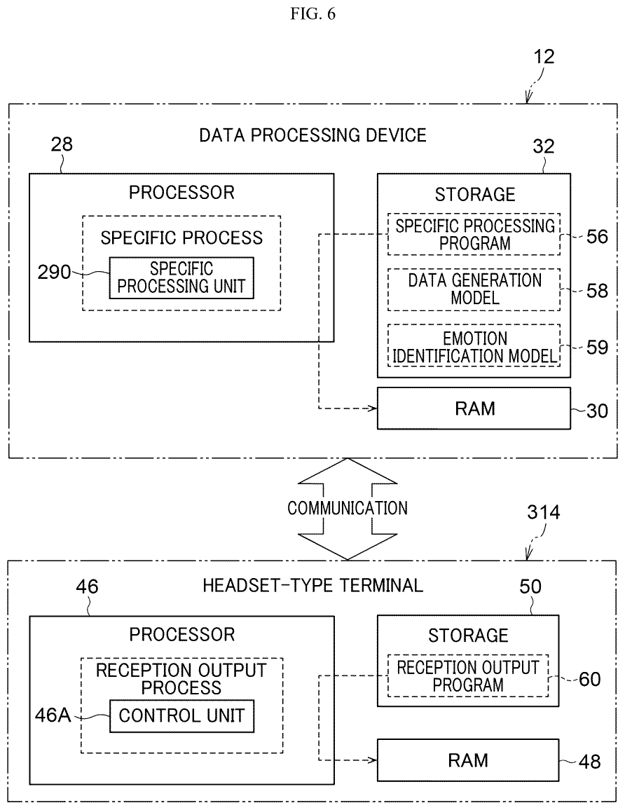

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

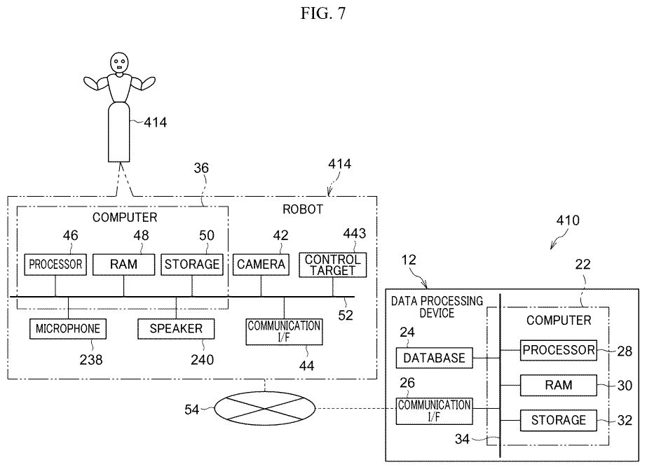

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

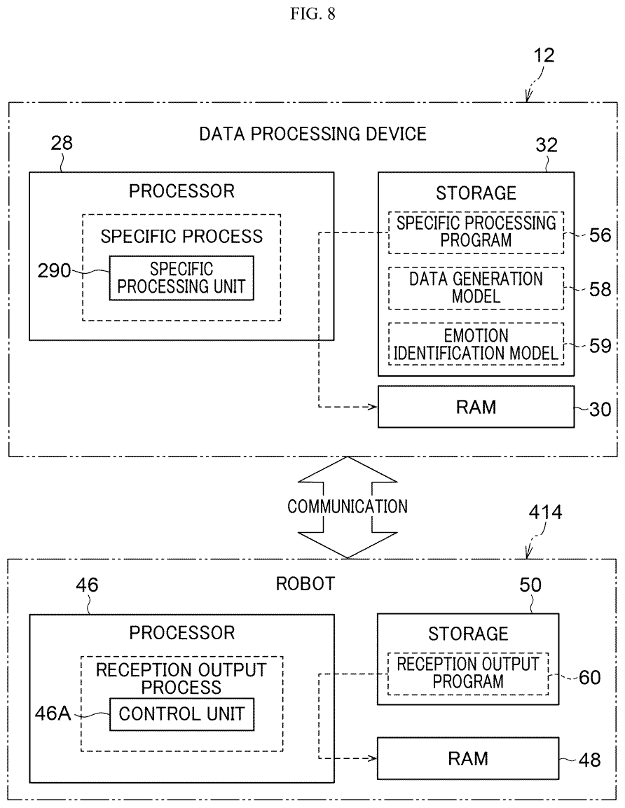

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

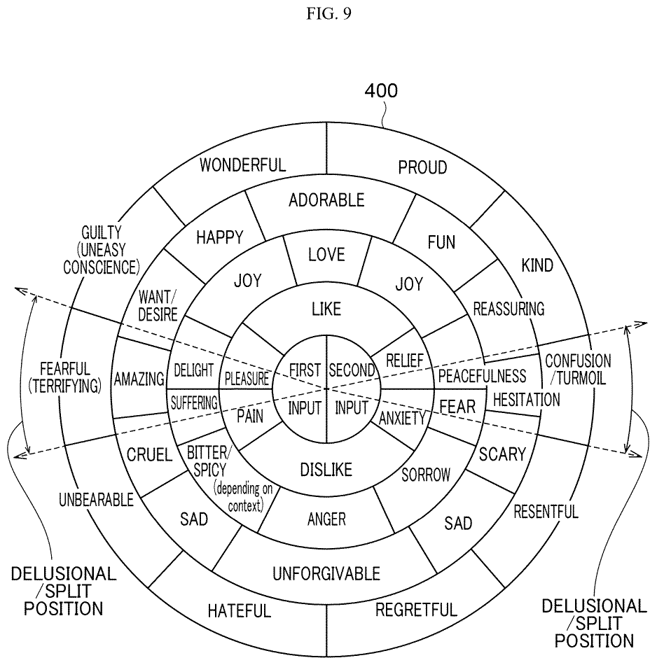

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

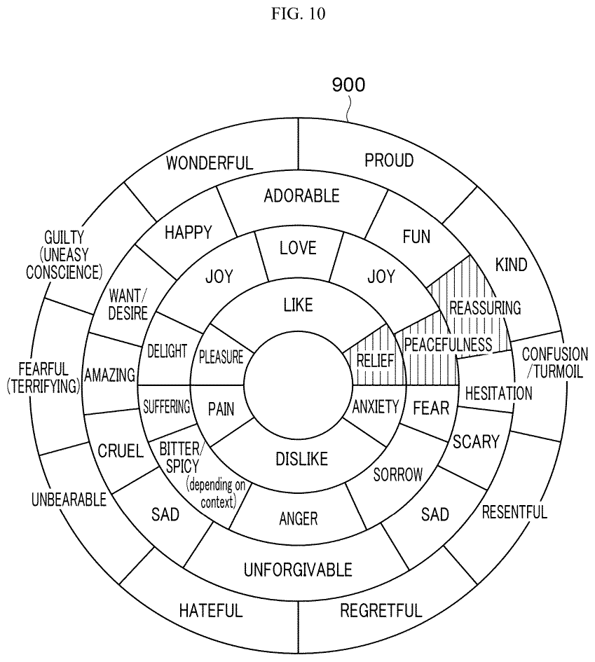

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
analyze learning request data including learning target information received from a user terminal, the learning request data including control information regarding a number of questions, a language type, and a difficulty level, and generate a prompt sentence for instructing a generative AI model to generate a plurality of inquiries for evaluating a degree of understanding of the learning target information,
generate model call request data including the prompt sentence for input to the generative AI model, transmit the model call request data via a network, receive inquiry generation result data from the generative AI model, analyze the inquiry generation result data, structure the inquiry generation result data into inquiry information in a format presentable on the user terminal, and store the inquiry information in a recording medium and transmit the inquiry information to the user terminal,
store user answer data received from the user terminal in association with the inquiry information stored in the recording medium, generate a prompt sentence for causing the generative AI model to perform understanding degree evaluation and feedback generation based on the user answer data, transmit model call request data including the prompt sentence, receive evaluation result data from the generative AI model, analyze the evaluation result data, and transmit, to the user terminal, understanding degree indices and explanation information based on the evaluation result data,
extract related terms and peripheral fields based on the learning target information and the understanding degree indices by using a natural language processing program or a recommendation processing program, search for related content candidates including book information, video information, or other entertainment information, select one or more of the related content candidates, and generate related content presentation information for presentation of the selected related content candidates on the user terminal, and
update learning progress information based on the user answer data and the understanding degree indices, generate control information for stepwise generation of additional inquiries or follow-up inquiries by changing the prompt sentence for the generative AI model according to the learning progress information, and transmit, to the user terminal, inquiry information including the additional inquiries or the follow-up inquiries.

### (Supplementary 2)

The system according to supplementary 1,
wherein the processor is configured to, when analyzing the inquiry generation result data, convert text data obtained from the generative AI model into structured data by extracting individual inquiry sentences based on line break information, numbering information, or data description format information, and register the inquiry sentences as inquiry information by assigning, to each inquiry sentence, an identifier, an index, and metadata.

### (Supplementary 3)

The system according to supplementary 1,
wherein the processor is configured to estimate a degree of user interest based on user operation information or stay time information in addition to the user answer data and the understanding degree indices, and dynamically generate a prompt sentence for causing the generative AI model to generate inquiries or content description sentences in which a difficulty level, a question range, or a question format is changed based on the degree of user interest and the learning target information.

### Application Example 1

### (Supplementary 1)

A system comprising a processor,
wherein the processor is configured to
receive character information indicating a learning target from a user terminal, analyze the character information by using a natural language processing unit, and extract a subject and a concept from the character information,
generate a prompt sentence that instructs a generative artificial intelligence model to generate a set of questions for measuring a user's level of understanding based on the extracted subject and concept, transmit the prompt sentence to the generative artificial intelligence model, and obtain the set of questions from the generative artificial intelligence model,
transmit the obtained set of questions to the user terminal for display, receive answer information of the user from the user terminal, analyze the answer information, and calculate an evaluation value for each answer and an overall understanding index by using an evaluation rule or a machine learning model,
identify a weak subject or concept based on the calculated understanding index and evaluation results of the answers, and generate a prompt sentence that instructs the generative artificial intelligence model to generate learning information or problems for reinforcing the weak subject or concept,
estimate an emotional state of the user based on the answer information or behavior history acquired from the user terminal, and generate a prompt sentence that instructs the generative artificial intelligence model to dynamically change a content or difficulty level of questions and presented content in response to the emotional state and the understanding index, and obtain feedback information and additional learning information from the generative artificial intelligence model, transmit the feedback information and the additional learning information to the user terminal, and cause the user terminal to present the feedback information and the additional learning information so that the user is able to plan a next learning step.

### (Supplementary 2)

The system according to supplementary 1,
wherein the processor is configured to reconstruct at least part of the set of questions based on an analysis result of the answer information of the user, generate a prompt sentence that instructs the generative artificial intelligence model to generate additional questions focusing on a subject or concept determined to have insufficient understanding, and transmit the prompt sentence so as to dynamically obtain the additional questions from the generative artificial intelligence model.

### (Supplementary 3)

The system according to supplementary 1,
wherein the processor is configured to integrally evaluate the understanding index of the user, operation history information indicating an interest of the user, and the estimated emotional state, determine a type, a difficulty level, and a presentation order of content including learning content or entertainment content based on an evaluation result, and generate a prompt sentence that instructs the generative artificial intelligence model to generate or summarize the content in accordance with the determination.

### Example 2

### (Supplementary 1)

A system comprising a processor,
wherein the processor is configured to
generate a prompt sentence based on target information acquired from a terminal and answer information from a user regarding the target information, the prompt sentence instructing a generative AI model to evaluate a degree of understanding of the user with respect to the target information and to generate question information according to the degree of understanding, and
analyze the answer information of the user by supplying the answer information to the generative AI model using the prompt sentence, extract one or more topics related to the target information based on an analysis result, and search, using the extracted topics, information resources stored in an information storage device, and
generate a prompt sentence that instructs the generative AI model to generate related information that deepens the understanding of the target information and surrounding information that expands an interest of the user away from the target information, the prompt sentence being based on the answer information and the extracted topics, and integrate a generation result from the generative AI model and a search result of the information resources to produce presentation information for output to the terminal, and estimate an emotional state of the user based on expressions included in the answer information of the user, and generate a prompt sentence that instructs the generative AI model to dynamically adjust a difficulty level and a detail level of question information or content information to be presented, based on the emotional state and the degree of understanding.

### (Supplementary 2)

The system according to supplementary 1,
wherein the processor is configured to
track, over time, changes in the degree of understanding and an interest of the user based on the answer information of the user and the related information and the surrounding information obtained from the generative AI model, and generate a prompt sentence that instructs the generative AI model to stepwise update question information or content information to be subsequently presented according to time-series information representing the changes.

### (Supplementary 3)

The system according to supplementary 1,
wherein the processor is configured to
restructure the related information and the surrounding information output from the generative AI model in association with classification information of a plurality of information resources stored in the information storage device, and generate a prompt sentence that instructs control of at least one of a display order and a grouping of topic groups to be presented to the user based on a result of the restructuring.

### Application Example 2

### (Supplementary 1)

A system comprising a processor,
wherein the processor is configured to
acquire, from a user terminal, identification information and meta-information of target information, acquire character information related to the target information based on the identification information and the meta-information, perform syntactic analysis and summarization processing on the character information, and extract a summary and main concepts of the target information,
generate, based on the summary, the main concepts, user attribute information, and learning history information, a prompt sentence for instructing a generative artificial intelligence model to generate a plurality of questions for measuring a degree of understanding of a user, obtain the plurality of questions from the generative artificial intelligence model, convert the obtained questions into structured data, and transmit the structured data to the user terminal, obtain answer data of the user to the plurality of questions from the user terminal, normalize the answer data by using natural language processing, calculate, by similarity computation between the normalized answer data and reference concepts extracted from the target information, an understanding index for each question, and evaluate an understanding level of the user with respect to the target information based on the understanding indexes, generate, based on the answer data and the understanding level, a prompt sentence for instructing the generative artificial intelligence model to output candidate topics for related information and peripheral information, obtain the candidate topics from the generative artificial intelligence model, search for information resources corresponding to the candidate topics, rank the information resources based on difficulty, relevance, and novelty, and structure the ranked information resources as recommendation information,
estimate an emotional state of the user based on at least one of facial information, voice information, and operation history information obtained from the user terminal, generate, according to the emotional state and the understanding level, a prompt sentence for instructing the generative artificial intelligence model to dynamically adjust content, number, and difficulty of questions or contents, and output questions or contents regenerated according to the generated prompt sentence as data for presentation to the user terminal, and obtain, from the user terminal, user selection information regarding the recommendation information and behavioral log information including viewing time or browsing time, update an interest vector and preference parameters of the user based on the behavioral log information, and adjust contents of a subsequently generated prompt sentence by using the updated interest vector and preference parameters so as to sequentially increase a degree of individualization of question generation and content recommendation.

### (Supplementary 2)

The system according to supplementary 1,
wherein the processor is configured to dynamically generate, based on the answer data of the user, the understanding level, and user selection results for the recommendation information, a prompt sentence for instructing the generative artificial intelligence model to generate additional introductory questions or advanced questions focusing on at least one of user error tendencies, unlearned concepts, and preferred media types, and to sequentially transmit the generated additional introductory questions or advanced questions to the user terminal.

### (Supplementary 3)

The system according to supplementary 1,
wherein the processor is configured to generate, based on the understanding level, the emotional state, and the interest vector, a prompt sentence for instructing the generative artificial intelligence model to output a plurality of content candidates including both learning information resources and entertainment information resources, select at least an educational content group and an entertainment content group from the plurality of content candidates, and output recommendation information including presentation control information for causing the user terminal to present the educational content group and the entertainment content group in a distinguishable manner.

What is claimed is:

1. A system comprising:
circuitry configured to:
receive, via a communication interface coupled to a packet-switched network, input data from a terminal device and store the input data in a storage device;
generate a first prompt sentence by applying a first prompt template to the input data, the first prompt sentence instructing a generative neural network model to generate a plurality of inquiry items for evaluating a degree of understanding of the input data, and transmit first model call request data comprising the first prompt sentence to the generative neural network model via the communication interface;
receive inquiry generation result data from the generative neural network model, parse the inquiry generation result data to extract individual inquiry sentences based on structural markers in the result data, and store structured inquiry information comprising the extracted inquiry sentences in the storage device and transmit the structured inquiry information to the terminal device via the communication interface;
receive response data from the terminal device, generate a second prompt sentence by applying a second prompt template to the inquiry items and the response data, the second prompt sentence instructing the generative neural network model to evaluate a degree of understanding and generate explanation information based on the response data, and transmit second model call request data comprising the second prompt sentence to the generative neural network model;
receive evaluation result data from the generative neural network model, parse the evaluation result data to extract an understanding index value and explanation information, and transmit the understanding index value and the explanation information to the terminal device via the communication interface;
extract related terms and peripheral fields from the input data and the understanding index value using a natural language processing program, identify content candidates from the storage device based on the related terms and peripheral fields, and transmit content presentation information comprising the identified content candidates to the terminal device; and
compute an interest value based on interaction log data received from the terminal device, update learning progress information based on the response data and the understanding index value, generate a third prompt sentence encoding difficulty adjustment parameters derived from the interest value and the learning progress information, and transmit additional inquiry information obtained from the generative neural network model using the third prompt sentence to the terminal device via the communication interface.

2. The system according to claim 1, wherein the circuitry is configured to construct the first prompt sentence by inserting the input data into a template that specifies a requested number of inquiry items, a language type parameter, and a difficulty level parameter.

3. The system according to claim 2, wherein the circuitry is configured to parse the inquiry generation result data by splitting the result data at line break characters, removing empty lines and leading numbering tokens, and assigning an identifier, an index value, and a creation timestamp to each extracted inquiry sentence before storing the inquiry sentences as rows in a database table.

4. The system according to claim 3, wherein the circuitry is configured to store the structured inquiry information as records in a relational database indexed by a session identifier, and associate each response record and each evaluation result record with the corresponding session identifier and inquiry identifier using foreign key associations.

5. The system according to claim 4, wherein the circuitry is configured to compute the learning progress information by aggregating understanding index values across a plurality of sessions for the same input data topic, calculating a statistical measure of the aggregated values, and storing the statistical measure in the storage device for use in constructing the third prompt sentence.

6. The system according to claim 5, wherein the circuitry is configured to encode the difficulty adjustment parameters in the third prompt sentence as natural language constraints including at least one of a scope constraint specifying a question range, a difficulty constraint specifying a difficulty level, or a format constraint specifying a question type.

7. The system according to claim 1, wherein the circuitry is configured to compute the interest value by calculating a dwell time metric from stay time information indicating a duration for which the terminal device remained on each inquiry item, and a frequency metric from user operation information indicating interaction events, and combining the dwell time metric and the frequency metric to produce a normalized interest score.

8. The system according to claim 7, wherein the circuitry is configured to apply a mapping function to a combination of the normalized interest score and the understanding index value to determine a difficulty level indicator and a detail level indicator, and insert the difficulty level indicator and the detail level indicator as parameters into the third prompt sentence.

9. The system according to claim 1, wherein the circuitry is configured to estimate an emotional state of a user based on at least one of text features extracted from the response data, voice data received from the terminal device, or image data received from the terminal device, and generate a fourth prompt sentence that incorporates the emotional state as a parameter controlling a tone or complexity of inquiry items generated by the generative neural network model.

10. The system according to claim 9, wherein the circuitry is configured to apply a decision algorithm that maps a combination of the understanding index value and the emotional state to specific difficulty and detail levels, and encode the mapped levels as explicit constraints in the fourth prompt sentence.

11. The system according to claim 1, wherein the circuitry is configured to apply the natural language processing program to tokenize the input data, compute embedding vectors for terms extracted from the input data, and calculate similarity scores between the embedding vectors and stored content item descriptors, and select content candidates whose similarity scores exceed a threshold value.

12. The system according to claim 11, wherein the circuitry is configured to generate surrounding field data comprising topic areas adjacent to but not identical with the related terms, by supplying a prompt sentence to the generative neural network model that instructs the model to identify topics that extend a conceptual boundary of the input data, and to combine the surrounding field data with the content candidates in the content presentation information.

13. The system according to claim 12, wherein the circuitry is configured to associate the content candidates and the surrounding field data with classification labels stored in the storage device, group the associated content candidates into topic groups based on shared classification labels, and calculate relevance scores for the topic groups based on the related terms and the understanding index value to determine a display order in the content presentation information.

14. The system according to claim 1, wherein the circuitry is configured to maintain a multi-model configuration in which a first generative neural network model is used for generating inquiry items and a second generative neural network model is used for evaluating response data, and select between the first generative neural network model and the second generative neural network model based on a model selection mapping that associates input data categories with specific models.

15. The system according to claim 14, wherein the circuitry is configured to detect a prompt formatting deviation when a ratio of evaluation result data that requires fallback parsing exceeds a threshold value, and modify the second prompt sentence to include an explicit formatting constraint that corrects the detected deviation in subsequent model calls.

16. The system according to claim 1, wherein the circuitry is configured to update an interest vector and preference parameters of the user based on behavioral log information received from the terminal device, the behavioral log information comprising at least one of content viewing time, browsing time, or selection information, and adjust a content portion of a subsequently generated prompt sentence using the updated interest vector and preference parameters to increase a degree of individualization of inquiry generation over successive sessions.

17. The system according to claim 16, wherein the circuitry is configured to generate a prompt sentence that instructs the generative neural network model to output a plurality of content candidates comprising both educational content resources and entertainment content resources, select at least one educational content group and one entertainment content group from the plurality of content candidates, and include presentation control information in the content presentation information for causing the terminal device to present the educational content group and the entertainment content group in a distinguishable manner.

18. A system comprising:
circuitry configured to:
receive, via a communication interface coupled to a packet-switched network, input data and control parameters from a terminal device, the control parameters comprising a requested number of inquiry items, a language type, and a difficulty level;
generate a first prompt sentence by inserting the input data and the control parameters into a first template, transmit first model call request data comprising the first prompt sentence to a generative neural network model, receive inquiry generation result data, parse the inquiry generation result data by extracting individual inquiry sentences based on structural markers, assign identifiers to the extracted inquiry sentences, store the extracted inquiry sentences as structured inquiry information in a storage device, and transmit the structured inquiry information to the terminal device;
receive response data from the terminal device, generate a second prompt sentence by embedding the inquiry items and the response data in a second template that specifies a scoring range and an output format, transmit second model call request data comprising the second prompt sentence to the generative neural network model, receive evaluation result data, parse the evaluation result data to extract an understanding index value and explanation information by locating labeled output fields, and transmit the understanding index value and the explanation information to the terminal device; and
extract related terms from the input data using a natural language processing program, compute similarity scores between embedding vectors of the related terms and stored content descriptors, select content candidates based on the similarity scores, compute an interest value from dwell time data and interaction event data received from the terminal device, generate a third prompt sentence that encodes difficulty and detail level parameters derived from the understanding index value and the interest value, and transmit additional inquiry information and content presentation information to the terminal device via the communication interface.

19. The system according to claim 18, wherein the circuitry is configured to generate, based on the understanding index value and an emotional state estimated from the response data, a prompt sentence that instructs the generative neural network model to dynamically adjust a content level and a difficulty level of inquiry items to be presented, and update the interest value using behavioral log data received from the terminal device to sequentially personalize inquiry generation across sessions.

20. A method comprising:
receiving, via a communication interface coupled to a packet-switched network, input data from a terminal device and storing the input data in a storage device;
generating a first prompt sentence by applying a first prompt template to the input data, the first prompt sentence instructing a generative neural network model to generate a plurality of inquiry items for evaluating a degree of understanding of the input data, and transmitting first model call request data comprising the first prompt sentence to the generative neural network model via the communication interface;
receiving inquiry generation result data from the generative neural network model, parsing the inquiry generation result data to extract individual inquiry sentences based on structural markers in the result data, and storing structured inquiry information comprising the extracted inquiry sentences in the storage device and transmitting the structured inquiry information to the terminal device via the communication interface;
receiving response data from the terminal device, generating a second prompt sentence by applying a second prompt template to the inquiry items and the response data, the second prompt sentence instructing the generative neural network model to evaluate a degree of understanding and generate explanation information based on the response data, and transmitting second model call request data comprising the second prompt sentence to the generative neural network model;
receiving evaluation result data from the generative neural network model, parsing the evaluation result data to extract an understanding index value and explanation information, and transmitting the understanding index value and the explanation information to the terminal device via the communication interface;
extracting related terms and peripheral fields from the input data and the understanding index value using a natural language processing program, identifying content candidates from the storage device based on the related terms and peripheral fields, and transmitting content presentation information comprising the identified content candidates to the terminal device; and
computing an interest value based on interaction log data received from the terminal device, updating learning progress information based on the response data and the understanding index value, generating a third prompt sentence encoding difficulty adjustment parameters derived from the interest value and the learning progress information, and transmitting additional inquiry information obtained from the generative neural network model using the third prompt sentence to the terminal device via the communication interface.
